(19) United States
(12) Patent Application Publication
(10) Pub. No.: US 2024/0249546 A1
(43) Pub. Date: Jul. 25, 2024

(54) INFORMATION PROCESSING APPARATUS, INFORMATION PROCESSING SYSTEM, AND STORAGE MEDIUM

(71) Applicant: CANON KABUSHIKI KAISHA, Tokyo (JP)

(72) Inventor: KEISUI OKUMA, Kanagawa (JP)

(21) Appl. No.: 18/416,230

(22) Filed: Jan. 18, 2024

(30) Foreign Application Priority Data
Jan. 20, 2023 (JP) 2023-007587

(51) Int. Cl. G06V 30/416; G06V 30/19; G06V 30/414

(52) U.S. Cl. CPC G06V 30/416; G06V 30/19133; G06V 30/19167; G06V 30/414

(57) ABSTRACT

Learning data is generated so as to correspond to documents in various layouts. An information processing apparatus generates layout data indicating a layout of a character string based on template data to define a layout of a document, and generates learning data based on the generated layout data, wherein the generated learning data are used for generating a learned model that extracts a named entity from a document image.

### BACKGROUND

### Field

The present disclosure relates to a technique for extracting character information from a document image.

### Description of the Related Art

There is a technique for extracting character strings of item values corresponding to a prescribed extraction target item such as a document number, a company name, a date, an amount of money, and a title out of images of documents called quasi-standard forms such as invoices, quote, and purchase orders, which are generated in different layouts that vary among issuance sources such as companies. In general, the above-mentioned extraction of a character string is realized by using the optical character recognition (OCR) technique and the named entity recognition (NER) technique. Specifically, using data on a character string obtained by character recognition from a document image as an input, the named entity recognition is first carried out based on a feature amount of the character string expressed by an embedded vector. In addition, a prescribed label such as a company name is attached to a character string corresponding to an item value of an extraction target obtained as a result of the named entity recognition processing. The named entity recognition is generally carried out by using a learned model that is obtained by machine learning. A large number of sets of learning data each including character string data used as the learning data and labeled training data to which a label (hereinafter referred to as a “ground truth label”) that indicates ground truth of the character string of the extraction target is attached in advance are required in order to obtain the learned model for the named entity recognition.

Japanese Patent Laid-Open No. 2022-116979 discloses a technique for generating character string data used as learning data. Specifically, the technique disclosed in Japanese Patent Laid-Open No. 2022-116979 is designed to generate character string data that is different from a character string prepared in advance by saving an important word in the character string and replacing other words with words similar to these words.

According to the technique disclosed in Japanese Patent Laid-Open No. 2022-116979, it is possible to generate the character string data used as the learning data. However, the character string data thus generated is the mere character string data that corresponds to the same quasi-standard forms, and does not correspond to quasi-standard forms in various layouts. In other words, the technique disclosed in Japanese Patent Laid-Open No. 2022-116979 is designed to generate the character string by replacing part of the words in the character string and is therefore unable to generate learning data corresponding to documents in various layouts.

### SUMMARY

The present disclosure provides embodiments that include an information processing apparatus configured to generate learning data used for generating a learned model, the information processing apparatus comprising: one or more processors; and one or more memories storing one or more programs configured to be executed by the one or more processors, the one or more programs including instructions for generating layout data indicating a layout of a character string based on template data to define a layout of a document, and generating the learning data based on the generated layout data, wherein the generated learning data are used for generating the learned model that extracts a named entity from a document image.

Further features of various embodiments will become apparent from the following description of exemplary embodiments with reference to the attached drawings.

### BRIEF DESCRIPTION OF THE DRAWINGS

FIGS. 1A and 1B are block diagrams showing an example of a configuration of an information processing system;

FIGS. 2A to 2C are block diagrams showing an example of hardware configurations of an image processing apparatus, a learning apparatus, and an information processing server;

FIGS. 3A and 3B are processing sequence diagrams showing an example of a processing flow of the information processing system;

FIG. 4 is a flowchart showing an example of a processing flow of the learning apparatus;

FIG. 5A to 5C are diagrams for explaining examples of character string information and item value information;

FIG. 6 is a flowchart showing an example of a generation processing flow of a document image token by a token string generating unit;

FIGS. 7A to 7D are diagrams for explaining an example of generation processing of a document image token string by the token string generating unit;

FIGS. 8A and 8B are diagrams for explaining an example of generation processing of an item value token string by the token string generating unit;

FIG. 9 is a flowchart showing an example of a generation processing flow of a document image by an image generating unit;

FIGS. 10A to 10C are diagrams for explaining examples of templates;

FIG. 11 is a diagram showing an example of sub-template data;

FIGS. 12A and 12B are diagrams showing examples of item images;

FIG. 13 is a diagram showing an example of an item character string DB;

FIGS. 14A to 14C are diagrams for explaining an example of layout processing for laying out item images on a white image by the image generating unit;

FIG. 15 is a diagram showing an example of a document image generated by the image generating unit;

FIG. 16 is a flowchart showing an example of an obtainment processing flow of learned character string information by a generating unit;

FIGS. 17A to 17D are diagrams for explaining an example of obtainment processing of the learned character string information by the generating unit;

FIG. 18 is a flowchart showing an example of a processing flow by the information processing server;

FIGS. 19A and 19B are diagrams for explaining an example of an inference result of an item value extraction model;

FIG. 20 is a diagram showing an example of a confirmation screen for causing a user to confirm an item character string;

FIG. 21 is a flowchart showing an example of a processing flow by an information processing server according to Embodiment 2;

FIG. 22 is a flowchart showing an example of a flow of update processing of template data, sub-template data, and an item character string DB by the information processing server according to Embodiment 2;

FIGS. 23A to 23F are diagrams for explaining an example of determination processing as to whether or not a document image has an unknown layout according to Embodiment 2;

FIGS. 24A to 24C are diagrams showing examples of a permission confirmation screen, an editing screen, and an update confirmation screen according to Embodiment 2; and

FIGS. 25A and 25B are diagrams showing an example of an editing screen for editing template data and sub-template data according to Embodiment 3.

### DESCRIPTION OF THE EMBODIMENTS

Hereinafter, with reference to the attached drawings, the present disclosure explains some example embodiments in detail. Configurations shown in the following embodiments are merely exemplary and some embodiments of the present disclosure are not limited to the configurations shown schematically.

### Embodiment 1

### <Configuration of Information Processing System>

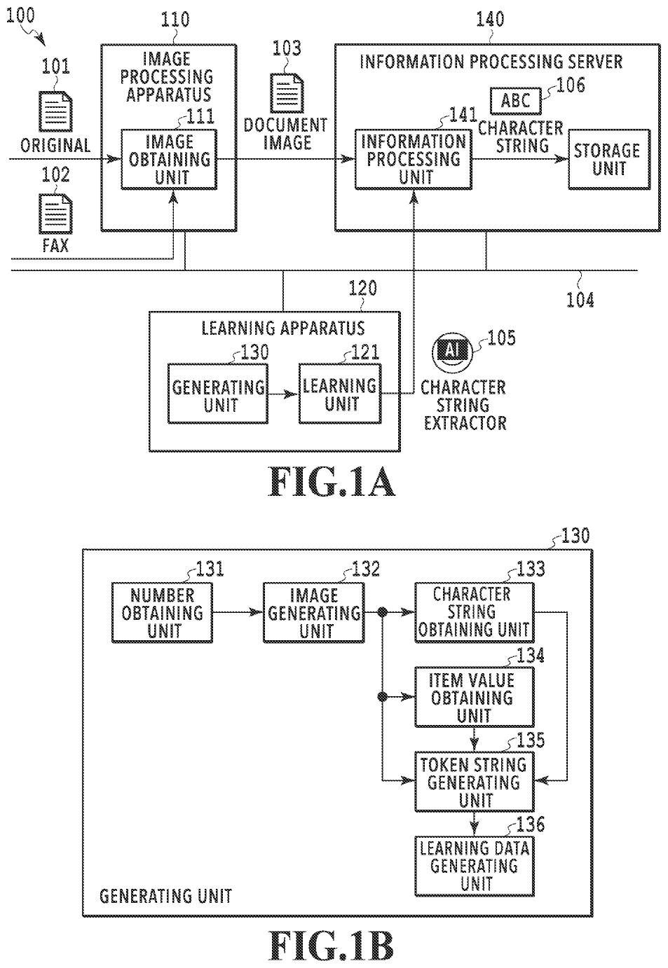

A configuration of an information processing system 100 will be described with reference to FIGS. 1A and 1B. FIG. 1A is a block diagram showing an example of a configuration of the information processing system 100 according to Embodiment 1. The information processing system 100 includes an image processing apparatus 110, a learning apparatus 120, and an information processing server 140. The image processing apparatus 110, the learning apparatus 120, and the information processing server 140 are communicably connected to one another through a network 104. The information processing system 100 is not limited to a configuration to connect the single image processing apparatus 110, the single learning apparatus 120, and the single information processing server 140 to the network 104, but may also be configured to connect more than one image processing apparatus 110, more than one learning apparatus 120, and more than one information processing server 140 to the network 104. For example, the information processing servers 140 may include a first server device provided with hardware that can perform high-speed computing and a second server device provided with a high-capacity storage medium, which are communicably connected to each other through the network 104.

The image processing apparatus 110 is formed from a multi-function peripheral (MFP) equipped with multiple functions, including a printing function, a scanning function, a facsimile function, and the like. The image processing apparatus 110 includes an image obtaining unit 111 as a functional configuration. For example, the image obtaining unit 111 generates a document image 103 by carrying out prescribed image scanning processing to optically read an original 101 printed on a print medium such as paper, and transmits data on the document image 103 to the information processing server 140. Meanwhile, the image obtaining unit 111 receives a facsimile data 102 transmitted from a not-illustrated facsimile machine, generates the document image 103 by carrying out prescribed facsimile image processing, and transmits the data on the document image 103 to the information processing server 140, for example. Here, the image processing apparatus 110 is not limited to the MFP provided with the scanning function, the facsimile function, and the like mentioned above. Instead, the image processing apparatus 110 may be formed from a personal computer (PC) and the like. In this case, the data on the document image 103 generated by a document generation application or the like to be activated on the PC that serves as the image processing apparatus 110 may be transmitted to the information processing server 140. Here, the data on the document image 103 is data in a prescribed image format, such as the Portable Document Format (PDF) format and the Joint Photographic Experts Group (JPEG) format.

The learning apparatus 120 is formed from a computer and the like, and includes a generating unit 130 that generates learning data, and a learning unit 121 that performs learning of a learning model by use of the learning data generated by the generating unit 130. Specifically, the generating unit 130 generates document images in the set number to be generated, which are different from one another. Here, the number to be generated is set by a user such, as an engineer (hereinafter simply referred to as the “engineer”), who develops the information processing system 100, for example. Meanwhile, each document image generated by the generating unit 130 is a document image that imitates a document image, such as the document image 103, as actual data obtained by the image processing apparatus 110. Subsequently, the generating unit 130 obtains character strings included as images in the respective generated document images, and generates sets of data on the obtained character strings and data obtained by attaching ground truth labels to character strings of extraction targets out of the aforementioned character strings collectively as sets of learning data.

The learning unit 121 conducts learning of a learning model prepared in advance by using the sets of learning data generated by the generating unit 130, thereby generating a learned model as a character string extractor 105 for inferring a character string of an extraction target included in the document image 103 as a learning result. This learned model will be hereinafter referred to as an item value extraction model. FIG. 1B is a block diagram showing an example of a functional configuration of the generating unit 130 according to Embodiment 1. The generating unit 130 includes a number obtaining unit 131, an image generating unit 132, a character string obtaining unit 133, an item value obtaining unit 134, a token string generating unit 135, and a learning data generating unit 136. Details of processing by the respective units included in the generating unit 130 as its functional configuration will be described later.

The information processing server 140 is formed from a computer or the like and includes an information processing unit 141 as a functional configuration, which obtains character strings included as images in the document image 103 and extracts a predetermined character string 106 of an extraction target out of the obtained character strings. The information processing unit 141 generates and displays a display image which includes the extracted character string 106 as an image, thereby presenting the character string 106 to a user, such as an end user (hereinafter simply referred to as the “user”). The information processing unit 141 may output data on the extracted character string 106 and cause a storage device, such as a hard disk drive, to store the outputted data. Specifically, the information processing unit 141 first executes OCR processing on the document image 103 and obtains the character strings as a result of optical character recognition by the OCR processing. Subsequently, the information processing unit 141 classifies and extracts the predetermined character string 106 of the extraction target out of the obtained character strings by using the character string extractor 105 (the item value extraction model). Here, the character string 106 of the extraction target is any of a proper noun, such as a personal name and a geographical name; a date expression; an amount-of-money expression; and the like having various expressions depending on the country or the language, which are generally referred to as named entities. Examples of such an extraction target item include a company name, date of issuance, a total amount of money, a document name, and the like.

The network 104 is realized by a local area network (LAN), a wide area network (WAN), and the like. The network 104 is a communication line that communicably connects the image processing apparatus 110, the learning apparatus 120, and the information processing server 140 to one another and enables transmission and reception of the data among the apparatuses.

### <Hardware Configurations of Respective Apparatuses>

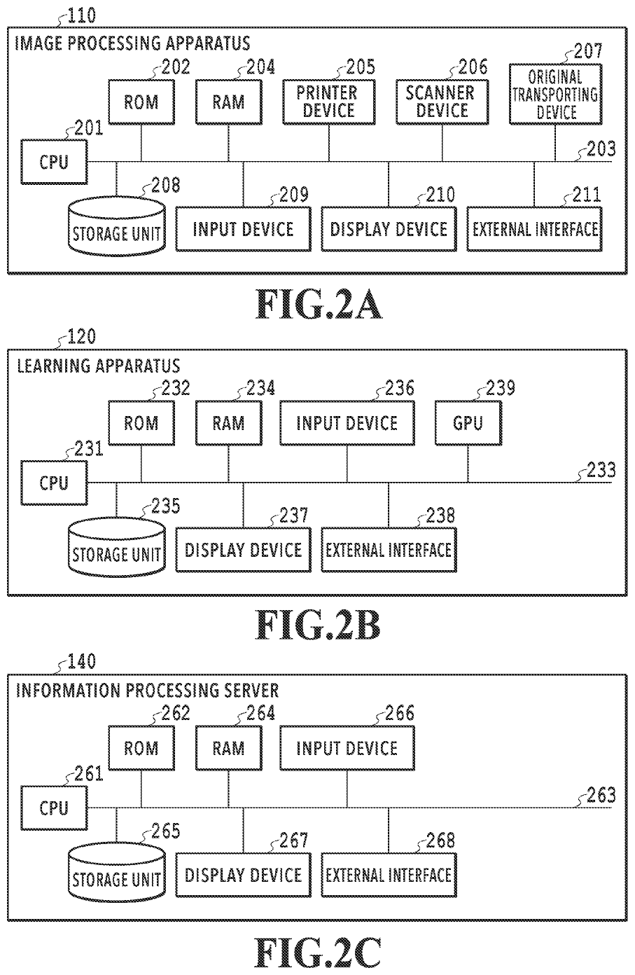

Hardware configurations of the image processing apparatus 110, the learning apparatus 120, and the information processing server 140 will be described with reference to FIGS. 2A to 2C. FIGS. 2A to 2C are block diagrams showing an example of the hardware configurations of the image processing apparatus 110, the learning apparatus 120, and the information processing server 140 according to Embodiment 1. Specifically, FIG. 2A is a block diagram showing an example of the hardware configuration of the image processing apparatus 110, FIG. 2B is a block diagram showing an example of the hardware configuration of the learning apparatus 120, and FIG. 2C is a block diagram showing an example of the hardware configuration of the information processing server 140, respectively. As shown in FIG. 2A, the image processing apparatus 110 includes a CPU 201, a ROM 202, a RAM 204, a printer device 205, a scanner device 206, a storage unit 208, and an external interface 211 collectively as the hardware configuration. The respective units provided to the image processing apparatus 110 as its hardware configuration are connected to one another through a data bus 203 in such a way as to be able to transmit and receive the data to and from one another.

The CPU 201 is a processor for controlling an overall operation in the image processing apparatus 110. The CPU 201 activates the image processing apparatus 110 by executing an activation program stored in the ROM 202 and the like, and controls the operation of the image processing apparatus 110 by executing a control program stored in the storage unit 208 and the like. In this way, the respective functions of the image processing apparatus 110, including the printing function, the scanning function, the facsimile function, and the like, are realized. The ROM 202 is a non-volatile memory that stores programs or data which do not need to be changed. The ROM 202 stores the activation program used for activating the image processing apparatus 110, for example. The data bus 203 transmits and receives the data to and from the respective units provided to the image processing apparatus 110 as the hardware configuration. The RAM 204 is a volatile memory which is used as a work memory in the case where the CPU 201 executes the control program. The printer device 205 is an image output device that forms an image, such as a document image, obtained by the image processing apparatus 110 on a print medium, such as paper. The scanner device 206 is an image input device that optically reads a print medium, such as paper, on which characters, graphics, and the like are formed, thereby obtaining a scanned image of a document image and the like.

An original transporting device 207 is formed from an automatic document feeder (ADF) and the like, which finds originals placed on a platen and transports the found originals one by one to a reading position in the scanner device 206. The storage unit 208 is an auxiliary storage device, such as a hard disk drive (HDD), which stores the control program, data such as the data on the document image, and so forth. An input device 209 is an operational input device, such as a touch panel and hard keys, which accepts an input operation from the user to the image processing apparatus 110. A display device 210 is a display device formed from a liquid crystal display unit and the like, which displays a setting screen for the image processing apparatus 110, and the like. The external interface 211 is configured to connect the image processing apparatus 110 to the network 104, which receives facsimile data from a not-illustrated facsimile machine or transmits the document image data to the information processing server 140 and the like.

As shown in FIG. 2B, the learning apparatus 120 includes a CPU 231, a ROM 232, a RAM 234, a storage unit 235, an input device 236, a display device 237, an external interface 238, and a GPU 239 collectively as the hardware configuration. The respective units provided to the learning apparatus 120 as its hardware configuration are connected to one another through a data bus 233 in such a way as to be able to transmit and receive the data to and from one another. The CPU 231 is a processor for controlling an overall operation in the learning apparatus 120. The CPU 231 activates the learning apparatus 120 by executing an activation program stored in the ROM 232 and the like, and carries out generation processing of the learning data and the character string extractor 105 (the item value extraction model) by executing a control program stored in the storage unit 235 and the like. The ROM 232 is a non-volatile memory that stores programs or data which do not have to be changed. The ROM 232 stores the activation program used for activating the learning apparatus 120, for example. The data bus 233 transmits and receives the data to and from the respective units provided to the learning apparatus 120 as the hardware configuration.

The RAM 234 is a volatile memory which is used as a work memory in the case where the CPU 231 executes the control program. The storage unit 235 is an auxiliary storage device, such as an HDD, which stores the control program, data such as the data on the document images, and so forth. The input device 236 is an operational input device, such as a mouse and a keyboard, which accepts an input operation from the engineer to the learning apparatus 120. The display device 237 is a display device formed from a liquid crystal display unit and the like, which displays a setting screen for the learning apparatus 120, for example. The external interface 238 is configured to connect the learning apparatus 120 to the network 104. The external interface 238 receives image data from a not-illustrated PC and the like, receives the data on the document images from the image processing apparatus 110, and transmits the character string extractor 105 (the item value extraction model) to the information processing server 140, for example. The GPU 239 is a processor for image processing. For example, the GPU 239 executes computation for generating the character string extractor 105 (the item value extraction model) based on the data on the character string included in the provided document image in accordance with a control command given by the CPU 231.

As shown in FIG. 2C, the information processing server 140 includes a CPU 261, a ROM 262, a RAM 264, a storage unit 265, an input device 266, a display device 267, and an external interface 268 collectively as the hardware configuration. The respective units provided to the information processing server 140 as its hardware configuration are connected to one another through a data bus 263 in such a way as to be able to transmit and receive the data to and from one another. The CPU 261 is a processor for controlling an overall operation in the information processing server 140. The CPU 261 activates the information processing server 140 by executing an activation program stored in the ROM 262 and the like, and carries out information processing, such as character recognition and information extraction, by executing a control program stored in the storage unit 265 and the like. The ROM 262 is a non-volatile memory that stores programs or data which do not have to be changed. The ROM 262 stores the activation program used for activating the information processing server 140, for example.

The data bus 263 transmits and receives the data to and from the respective units provided to the information processing server 140 as the hardware configuration. The RAM 264 is a volatile memory which is used as a work memory in the case where the CPU 261 executes the control program. The storage unit 265 is an auxiliary storage device, such as an HDD, which stores the control program, the data on the document image 103, the character string extractor 105 (the item value extraction model), the data on the character string 106, and so forth. The input device 266 is an operational input device, such as a mouse and a keyboard, which accepts an input operation from the user to the information processing server 140. The display device 267 is a display device, such as a liquid crystal display unit, which displays a setting screen for the information processing server 140, for example. The external interface 268 is configured to connect the information processing server 140 to the network 104. The external interface 268 receives the character string extractor 105 (the item value extraction model) from the learning apparatus 120 and receives the data on the document image 103 from the image processing apparatus 110.

### <Processing Sequence of Information Processing System>

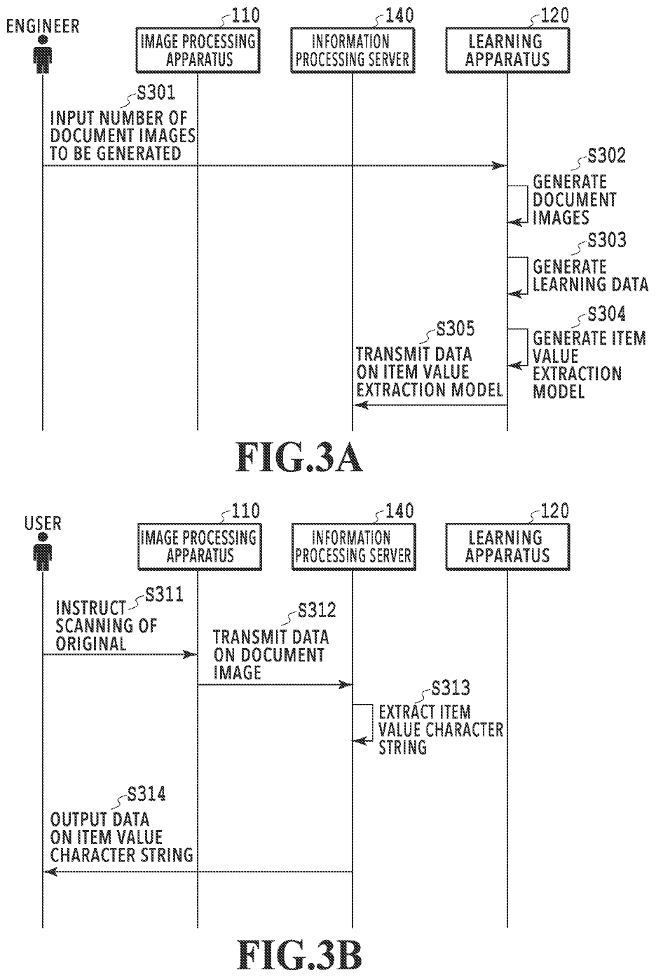

FIGS. 3A and 3B are processing sequence diagrams showing an example of a processing flow of the information processing system 100 according to Embodiment 1. Specifically, FIG. 3A is a sequence diagram for explaining an example of a processing flow in the case where the learning apparatus 120 generates the item value extraction model. Note that code “S” in the following description denotes a step. First, in S301, the engineer inputs the number of the document images to be generated by the learning apparatus 120 (the number to be generated) by using the input device 236, thereby setting the number to be generated to the learning apparatus 120. Next, in S302, the generating unit 130 of the learning apparatus 120 generates the document images in the number to be generated which are different from one another based on the number to be generated that is set in S301.

Then, in S303, the generating unit 130 of the learning apparatus 120 generates the learning data corresponding to the respective document images based on the document images generated in S302. Next, in S304, the learning unit 121 of the learning apparatus 120 causes the learning model to perform learning by using the multiple pieces of the learning data generated in S303, thereby generating the learned model (the item value extraction model) to extract the item value of the extraction target out of the inputted character strings. Next, in S305, the learning unit 121 of the learning apparatus 120 transmits the item value extraction model generated in S304 to the information processing server 140. The information processing server 140 causes the storage unit 265 to store the received item value extraction model.

FIG. 3B is a sequence diagram for explaining an example of a processing flow in the case where the information processing server 140 extracts the character string of the extraction target out of the character strings included in the document image 103. First, in S311, the user places the original 101 on the image processing apparatus 110 and instructs the image processing apparatus 110 to execute scanning of the original 101. Next, in S312, the image processing apparatus 110 transmits the data on the document image 103 obtained by scanning the original 101 to the information processing server 140.

Then, in S313, the information processing server 140 first receives the data on the document image 103 transmitted in S312 and obtains the data on the character strings included in the document image 103. Subsequent to S313, using the item value extraction model, the information processing server 140 extracts a character string of an item value (hereinafter referred to as an “item character string”) of the extraction target out of the character strings obtained in S313. Next, in S314, the information processing server 140 displays the item character string extracted in S313 on the display device 267 and the like as a display image, for example. The information processing server 140 may output the data on the item character string extracted in S313 to the storage unit 265 and the like so as to cause the storage unit 265 to store the data.

### <Generation Processing of Item Value Extraction Model>

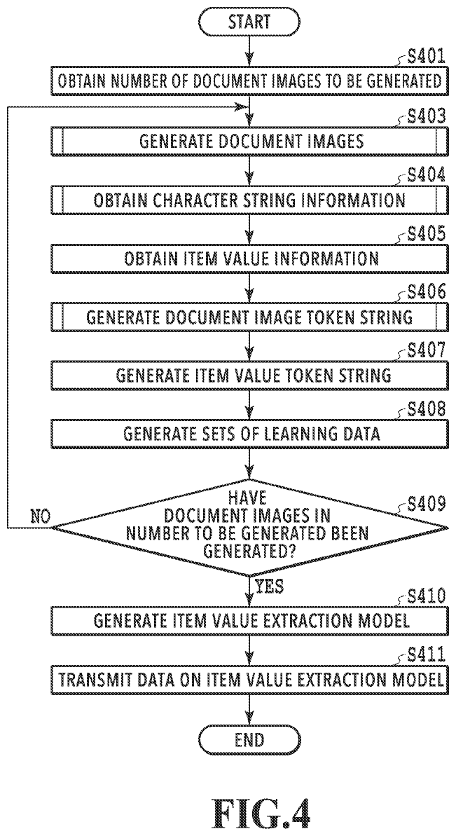

FIG. 4 is a flowchart showing an example of a processing flow of the learning apparatus 120 according to Embodiment 1. Here, a control program for executing respective steps in FIG. 4 is stored in any of the ROM 232, the RAM 234, and the storage unit 235 of the learning apparatus 120 and is executed by any of the CPU 231 and the GPU 239 of the learning apparatus 120. First, in S401, the number obtaining unit 131 of the generating unit 130 obtains information indicating the number of document images to be generated. Specifically, the number obtaining unit 131 obtains the value inputted by the engineer in S301 of FIG. 3 as the information indicating the number to be generated, for example. Note that the information indicating the number to be generated may be stored in the storage unit 235 and the like in advance. Next, in S403, the image generating unit 132 of the generating unit 130 generates the document images. Details of the generation processing of a document image by the image generating unit 132 will be described later.

Then, in S404, the character string obtaining unit 133 of the generating unit 130 obtains information indicating the character strings (hereinafter referred to as “character string information”) included in the document images generated in S403. Specifically, the character string obtaining unit 133 executes the OCR processing on the document images generated in S403, and obtains information (the character string information) indicating the character strings obtained as a result of character recognition by the OCR processing. Details of the character string information to be obtained by the character string obtaining unit 133 will be described later. Next, in S405, the item value obtaining unit 134 of the generating unit 130 obtains information indicating an item value (hereinafter referred to as “item value information”) of an extraction target out of the character strings indicated by the character string information obtained in S404. Details of the item value information to be obtained by the item value obtaining unit 134 will be described later. The character string information and the item value information will be hereinafter collectively referred to as learned character string information.

Then, in S406, the token string generating unit 135 of the generating unit 130 generates a token string corresponding to the character strings (hereinafter referred to as a “document image token string”) indicated by the character string information based on the document images generated in S403 and on the character string information obtained in S405. Details of generation processing of the document image token string by the token string generating unit 135 will be described later. Next, in S407, the token string generating unit 135 of the generating unit 130 generates a token string corresponding to the item value (hereinafter referred to as an “item value token string”) indicated by the item value information obtained in S405. Details of generation processing of the item value token string by the token string generating unit 135 will be described later.

Then, in S408, the learning data generating unit 136 of the generating unit 130 generates a set of learning data used for learning the learning model in generating the item value extraction model. Specifically, the learning data generating unit 136 generates the set of learning data that includes the document image token string generated in S406 and the item value token string generated in S407. For example, the item value extraction model is generated by supervised learning of the learning model, the document image token string is used as inputted data to the learning model, and the item value token string is used as the ground truth label (also referred to as “labeled training data”). The learning data generating unit 136 causes the storage unit 235 and the like to store the sets of learning data.

Next, in S409, the image generating unit 132 determines whether or not the document images in the number to be generated being obtained in S401 have been generated, for example. In the case where it is determined in S409 that the document images in the number to be generated have not been generated, the generating unit 130 repeatedly executes the processing from S402 to S409 until it is determined in S409 that the document images in the number to be generated have been generated. In this case, the image generating unit 132 generates a document image which is different from one or more document images generated so far, for example. In the case where it is determined in S409 that the document images in the number to be generated have been generated, the learning unit 121 generates the item value extraction model in S410 by the learning such as the supervised learning while using the sets of learning data generated in S408.

The learning in the case of generating the item value extraction model may apply a publicly known machine learning method to be used in machine translation, document classification, named entity recognition, and the like based on a natural language. Specifically, examples of the machine learning method include Recurrent Neural Network (RNN), Sequence To Sequence (Seq2Seq), Transformer, Bidirectional Encoder Representation from Transformers (BERT), and the like. Meanwhile, this learning process may adopt not only the tokens corresponding to the respective character strings but also any of absolute coordinates of the character strings corresponding to the respective tokens in the document image and relative coordinates among the character strings corresponding to the respective tokens in the document image. The use of the absolute coordinates or the relative coordinates makes it possible to carry out the learning in consideration of not only relations among the tokens but also layouts of the character strings corresponding to the tokens in the document image as typified by a tendency that a document name is likely to be laid out at an upper part of the document image, for instance. In S411 subsequent to S410, the learning unit 121 transmits data on the item value extraction model generated in S410 to the information processing server 140. The information processing server 140 receives the data on the item value extraction model and causes the storage unit 265 of the information processing server 140 to store the data. After S411, the learning apparatus 120 terminates the processing of the flowchart shown in FIG. 4.

### <Character String Information and Item Value Information>

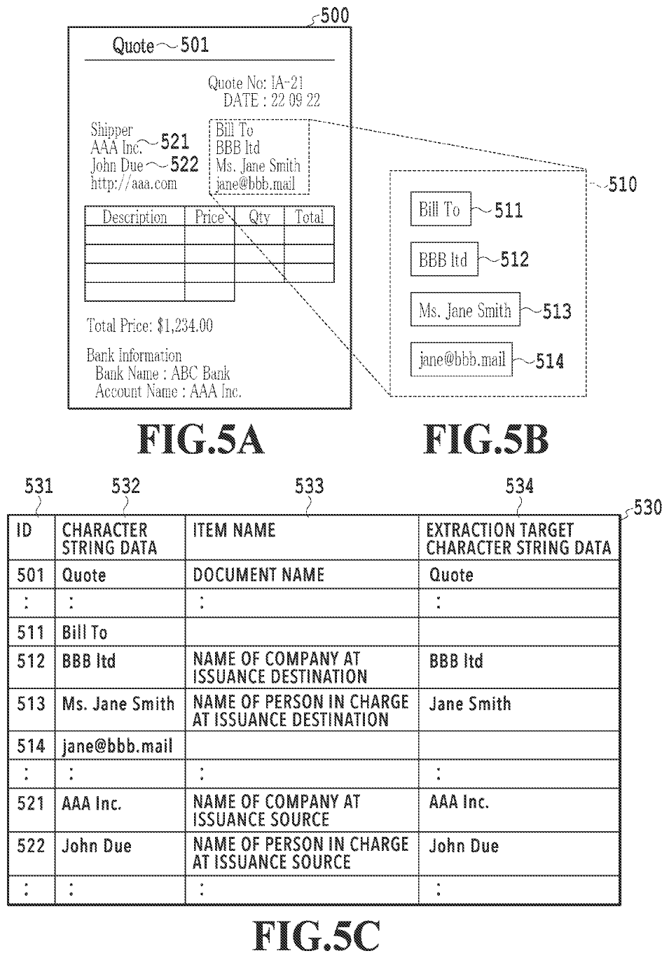

A description will be given of the character string information to be obtained by the character string obtaining unit 133 and the item value information to be obtained by the item value obtaining unit 134 with reference to FIGS. 5A to 5C. FIGS. 5A to 5C are diagrams for explaining examples of the character string information and the item value information according to Embodiment 1. Specifically, FIG. 5A is a diagram showing an example of a document image 500 generated by the image generating unit 132, and FIG. 5B is a diagram showing examples of regions 511 to 514 of character strings to be included in a region 510 of the document image 500. Meanwhile, FIG. 5C is a diagram showing an example of learned character string information 530 that includes information on the character strings (the character string information) included in the document image 500 and information indicating item values (the item value information) of extraction targets.

The learned character string information 530 stores respective values of an ID 531, a character string 532, an item name 533, and a character string corresponding to an item value of an extraction target (hereinafter referred to as an “extraction target character string”) 534. The ID 531 stores data that can uniquely identify each of the regions 511 to 514 and the like, as typified by a number to be provided to each of the regions corresponding to the respective character strings in the document image 500. The character string 532 stores the character string information, which is data on the character string included in each of the regions 511 to 514. The item name 533 stores data indicating a type of the item as typified by a name of the item to which the character string included in each of the regions 511 to 514 belongs. The extraction target character string 534 stores the item value information being data on the character string stored on a row of the character string 532 where the data indicating the type of the item is stored in the item name 533 out of the data on the character strings stored in the character string 532.

For example, the character string 532 on the row where the data “513” is stored in the ID 531 stores data on a character string “Ms. Jane Smith”. Likewise, data on a character string “name of person in charge at issuance destination” is stored on this row in the item name 533 and data on a character string “Jane Smith” is stored on this row in the extraction target character string 534, respectively. With reference to FIG. 5C, it turns out that a character string “AAA Inc.” corresponding to an item name “name of company at issuance source” is included in a region 521 of the document image 500 shown in FIG. 5A. Likewise, it turns out that a character string “John Due” corresponding to an item name “name of person in charge at issuance source” is included in a region 522 of the document image 500. On the other hand, a character string “Bill To” is stored in a character string 532 on a row where data “511” is stored in the ID 531. Here, the item name 533 on this row does not store data indicating the type of the item. Accordingly, no character string data is stored in the extraction target character string 534 on this row.

### <Generation Processing of Document Image Token String and Item Value Token String>

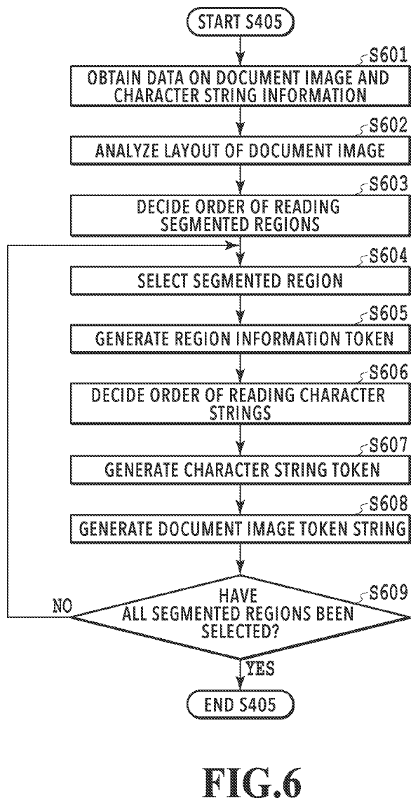

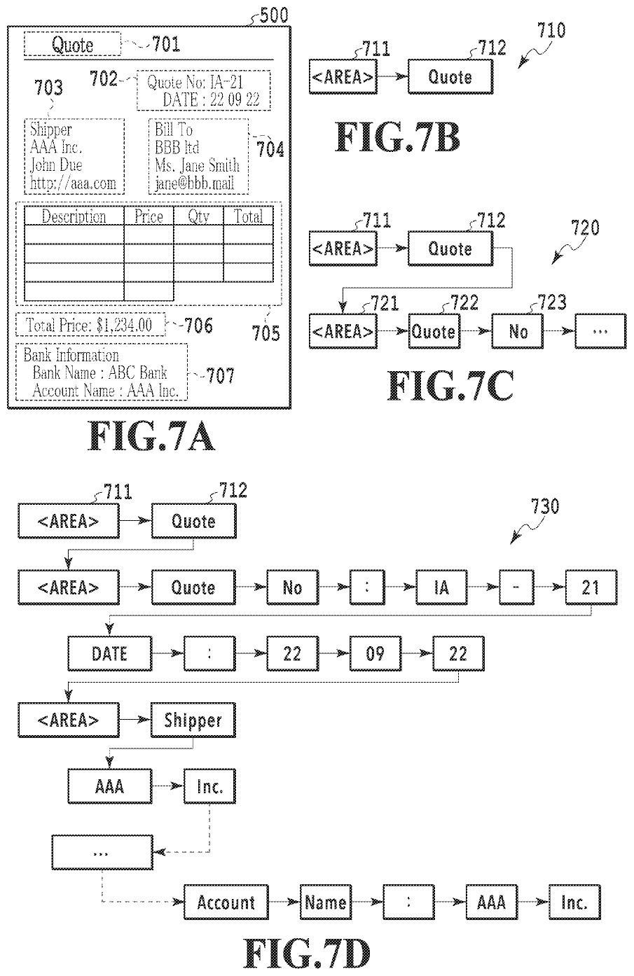

The generation processing of the document image token string by the token string generating unit 135 will be described with reference to FIGS. 6 to 7D. Although Embodiment 1 will be described on an assumption that the document image token string is generated by the generating unit 130 of the learning apparatus 120, the document image token string may be generated by the information processing unit 141 of the information processing server 140 instead. FIG. 6 is a flowchart showing an example of a generation processing flow of the document image token by the token string generating unit 135 according to Embodiment 1, which is a flowchart showing an example of the processing flow in S406 shown in FIG. 4. First, in S601, the token string generating unit 135 obtains the data on the document image generated by the image generating unit 132 and the character string information obtained by the character string obtaining unit 133. Specifically, the token string generating unit 135 obtains the data on the document image 500 generated in S403 and the data on the respective character strings stored in the character string 532 of the learned character string information 530 obtained in S405.

Next, in S602, the token string generating unit 135 performs segmentation into regions by analyzing a layout of the document image 500 obtained in S601, thereby obtaining information (hereinafter referred to as “segmented region information”) indicating the respective regions (hereinafter referred to as “segmented regions”) obtained by the segmentation. As for a method of region segmentation, blank regions, ruled lines, and the like in the document image 500 may be extracted, and regions surrounded by these regions may be segmented into constituent regions of the document. FIG. 7A shows an example of a result of segmentation of the regions in the document image 500 by the token string generating unit 135 according to Embodiment 1. FIG. 7A shows segmented regions 701 to 707 obtained by the layout analysis of the document image 500.

In S603 subsequent to S602, the token string generating unit 135 decides the order of reading the respective segmented regions obtained in S602. For example, the token string generating unit 135 decides the order of reading the respective segmented regions in such a way as to sequentially read the segmented regions while defining an upper left end of the document image 500 as a starting point and defining a lower right end thereof as an ending point. Next, in S604, the token string generating unit 135 selects an unprocessed segmented region out of the segmented regions in accordance with the reading order decided in S603. Next, in S605, the token string generating unit 135 generates a region information token by replacing information (the segmented region information) indicating the segmented region selected in S604 with a region information token “<AREA>”. The region information token can be used as a token indicating a boundary of the segmented region in the token string.

Then, in the case where the segmented region selected in S604 includes more than one character string, the token string generating unit 135 decides the order of reading the respective character strings with regard to the character strings included in the segmented region in S606. The segmented region 703 includes more than one character string, for example. In this case, the token string generating unit 135 decides the reading order in such a way as to sequentially read the character strings while defining an upper left end of the segmented region as a starting point and defining a lower right end thereof as an ending point, for example. Meanwhile, the segmented region 701 includes one character string, for example. In this case, the token string generating unit 135 decides the reading order in such a way as to define the relevant character string as a first character string. Next, in S607, the token string generating unit 135 converts data on the respective character strings arranged in accordance with the reading order decided in S606 into character string tokens. For example, the token string generating unit 135 extracts morphemes by subjecting the data on the respective character strings to a morphological analysis, and forms the individual morphemes obtained by the extraction into the character string tokens. Then, in S608, the token string generating unit 135 generates a document image token string by coupling the region information token obtained in S605 to the character string tokens obtained in S607.

FIG. 7B shows a document image token string 710 corresponding to the segmented region 701. The document image token string 710 is a token string formed by coupling two tokens a region information token 711 to a character string token 712. Likewise, FIG. 7C shows a document image token string 720 corresponding to the segmented regions 701 and 702. The document image token string 720 is a token string formed by coupling a region information token 721 and character string tokens 722, 723, and so forth arranged behind the document image token string 710.

In S609 subsequent to S608, the token string generating unit 135 determines whether or not all the segmented regions have been selected in S604. In the case of the determination in S609 that at least one of all the segmented regions is yet to be selected, the token string generating unit 135 repeatedly executes the processing from S604 to S609 until it is determined in S609 that all the segmented regions have been selected. In the case where it is determined in S609 that all the segmented regions have been selected, the token string generating unit 135 terminates the processing of the flowchart shown in FIG. 6. FIG. 7D shows an example of a document image token string 730 to be eventually generated.

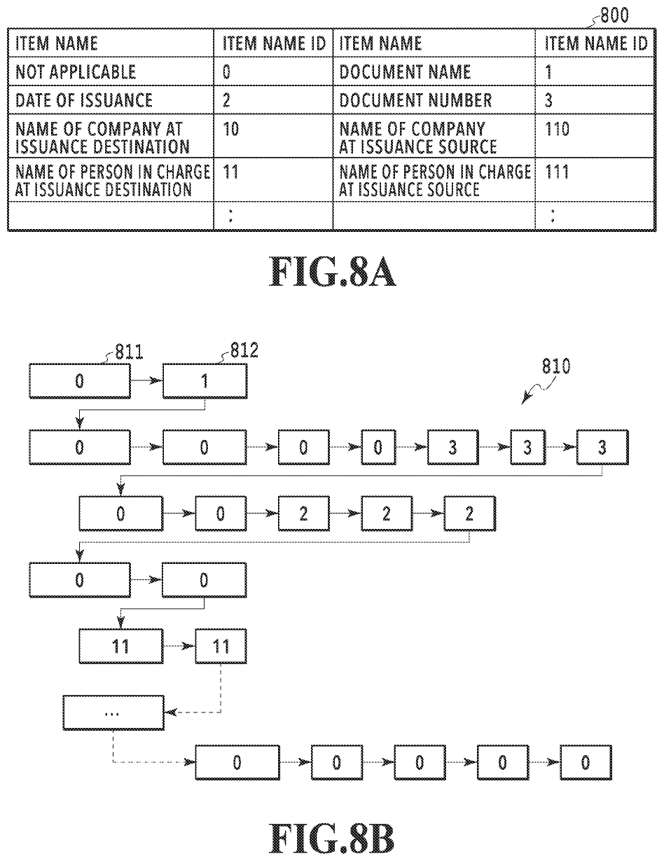

The generation processing of the item value token string by the token string generating unit 135 will be described with reference to FIGS. 8A and 8B. FIG. 8A is an item name ID list 800 that shows an example of correlations between item names of the extraction targets and item name IDs. FIG. 8B shows an example of an item value token string 810 corresponding to the document image token string 730 shown as the example in FIG. 7D. The token string generating unit 135 refers to the item name ID list 800 and replaces the respective tokens included in the document image token string 730 shown in FIG. 7D with values of the corresponding item name IDs, thereby generating the item value token string 810.

Specifically, in S407 shown in FIG. 4, the token string generating unit 135 first generates an item value token 811 by replacing “<AREA>” of the region information token 711 with “0” that represents a value of the item name ID corresponding to “not applicable”. Subsequently, the token string generating unit 135 generates an item value token 812 by replacing the character string token 712 corresponding to “Quote” being the character string included in the segmented region 701 (a region 501 shown in FIG. 5A) with “1” that represents a value corresponding to the item name ID indicating the “document name”. The item value token string 810 shown in FIG. 8B is generated by carrying out the similar processing on all the tokens included in the document image token string 730 shown in FIG. 7D. The values of the tokens included in the item value token string generated by the token string generating unit 135 are used as the ground truth labels (the labeled training data) in the supervised learning in the case of generating the item value extraction model.

Note that the values of the item name IDs shown in FIG. 8A and a method of attaching the item name IDs is not limited to those described above. For example, the token string generating unit 135 may generate the item value token string by using tags in a publicly known format such as the inside-outside-beginning (IOB) format and the begin, inside, last, outside, unit (BILOU) format as the values of the item name IDs. In the case of the IOB format, for instance, a tag that starts with “B-” may be added to a beginning item value token and a tag that starts with “I-” may be added to an inside item value token. Meanwhile, in the case of the BILOU format, a tag that starts with “L-” may be added to a last item value token and a tag that starts with “U-” may be added to a unique item value token in addition to the IOB format. In this way, it is possible to perform the learning by using the sets of learning data that clarify ranges of extracted character strings.

### <Generation Processing of Document Image>

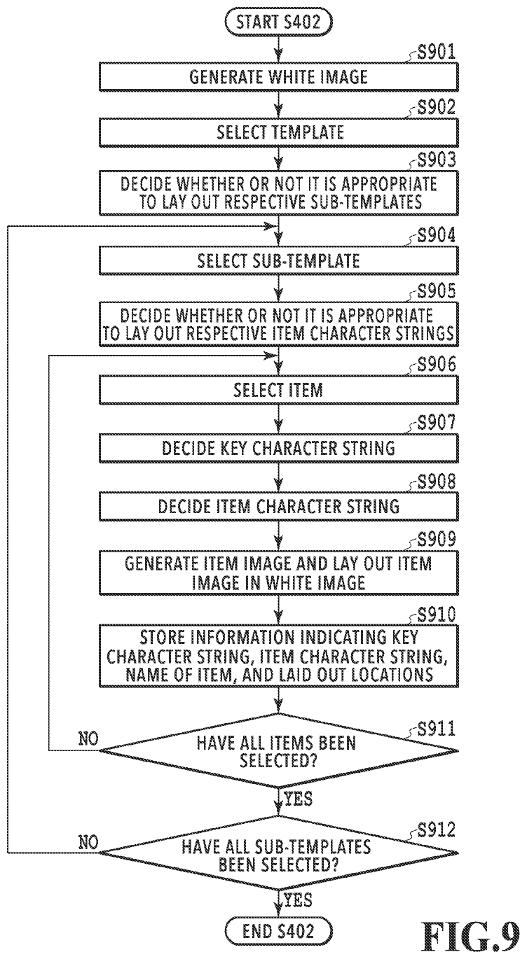

The generation processing of the document image by the image generating unit 132 will be described with reference to FIGS. 9 to 15. FIG. 9 is a flowchart showing an example of a generation processing flow of the document image by the image generating unit 132 according to Embodiment 1, which is a flowchart showing an example of the processing flow in S403 shown in FIG. 4. First, in S901, the image generating unit 132 generates a white image in which all pixels forming the basis for the generated document image are white. Specifically, the image generating unit 132 generates a white image having an image size in a case where the image processing apparatus 110 scans an original having a sheet size of A4 size, for example. To be more precise, the image generating unit 132 generates a white image having a width of 2480 px (pixels) and a height of 3508 px as the image size, for example. The aforementioned image size is a mere example and the image size of the white image generated by the image generating unit 132 may have any size. Next, among data on multiple templates (hereinafter referred to as “template data”) stored in the storage unit 235 and the like, the image generating unit 132 selects and obtains an arbitrary piece of the template data in S902. Here, the template data are assumed to be generated in advance by the engineer or the like and to be stored in advance in the storage unit 235 and the like.

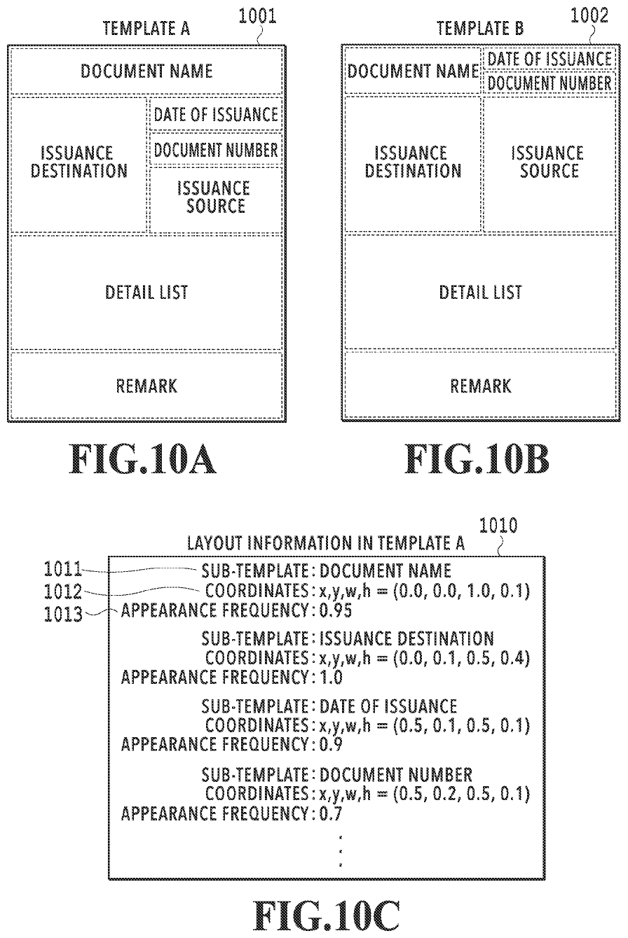

The templates will be described with reference to FIGS. 10A to 10C. FIGS. 10A and 10B are diagrams showing example of two templates that are different from each other, namely, a template 1001 (hereinafter referred to as a “template A”) and a template 1002 (hereinafter referred to as a “template B”). The pieces of template data including data on the template A, data on the template B, and the like are stored in the storage unit 235 and the like. Here, a template represents a layout of a form and includes information to define locations of respective regions of sub-templates to be laid out on the form. A sub-template defines each of constituents such as a document name and a name of an issuance destination to be included in the form.

FIG. 10C is a diagram showing an example of information (hereinafter referred to as “layout information”) 1010 that indicates the locations of the regions of the respective sub-templates in the template A shown in FIG. 10A. The layout information 1010 is stored depending on the template in the form of text data in a prescribed format, such as the JavaScript Object Notation (json) format. The layout information 1010 includes information indicating the locations of the regions of the respective sub-templates. A description will be given below of the sub-template of the document name as an example. A sub-template 1011 stores information indicating a type of the sub-template such as a name of the sub-template. Coordinates 1012 store information indicating the location, a size, and the like of the region to lay out the sub-template in the document image to be generated. Although a method of defining the coordinates 1012 may be any method, the coordinates 1012 will be hereinafter expressed by using normalized real numbers each in a range from 0 to 1 with which a location in a lateral direction represents a width of the image while a location in a longitudinal direction represents a height of the image based on an upper left end of the document image as the point of origin.

Assuming that the width of the document image has 2480 px and the height thereof has 3508 px, for example, the width of the region of the sub-template 1011 is equal to 2480 px because a value w at the coordinates 1012 is equal to 1.0. Meanwhile, the height of the region of the sub-template 1011 is equal to 350 px because a value h at the coordinates 1012 is equal to 0.1. Since both of values x and y are equal to 0.0, the coordinates at an upper left end of the region of the sub-template 1011 is expressed by (x, y)=(0, 0). An appearance frequency 1013 represents a probability to lay out the sub-template in the document image, which is defined by using a real number in a range from 0 to 1, for example. The sub-template is definitely laid out in the document image in the case where the appearance frequency is equal to 1. The sub-template is not laid out in the document image in the case where the appearance frequency is equal to 0. Since the value of the appearance frequency 1013 is equal to 0.95, the sub-template 1011 is laid out in the document image at the probability of 95% (percent).

In S903 subsequent to S902, the image generating unit 132 decides whether or not it is appropriate to lay out the respective sub-templates in the template into the document image. The appropriateness to lay out each of the sub-templates in the document image is decided at random by using a random number based on the values of the appearance frequencies defined for the respective sub-templates as shown in FIG. 10C as the example. Next, in S904, the image generating unit 132 selects one of the unprocessed sub-templates out of all the sub-templates decided to be laid out in S903.

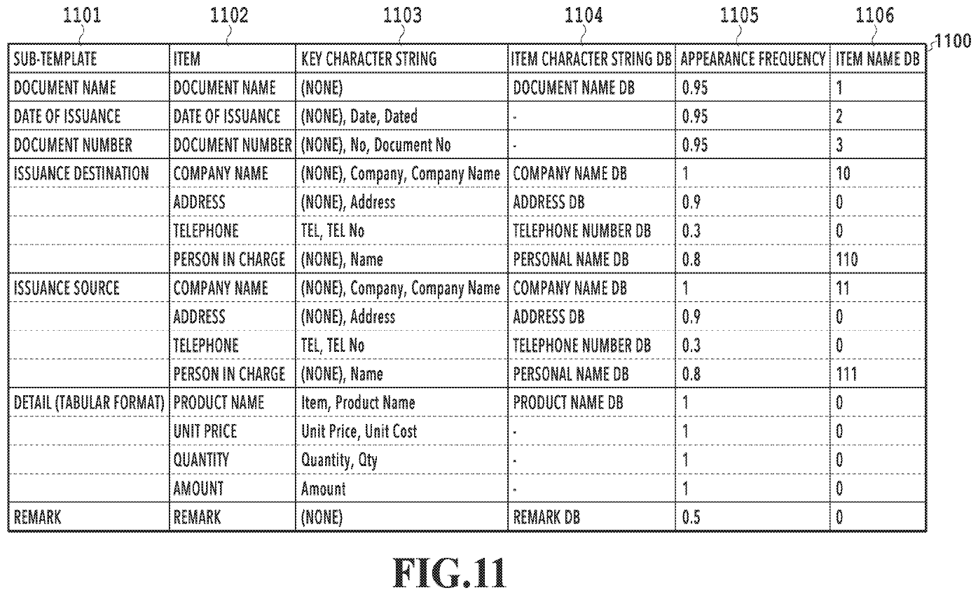

The sub-templates will be described with reference to FIG. 11. FIG. 11 is a diagram showing an example of information indicating the sub-templates (hereinafter referred to as “sub-template data”) 1100. The sub-template data are generated in advance by the engineer or the like and stored in advance in the storage unit 235 and the like. The image generating unit 132 obtains the sub-templates by reading the sub-template data. The sub-template data 1100 links a sub-template 1101, an item 1102, a key character string 1103, an item character string DB 1104, an appearance frequency 1105, and an item name ID 1106 to one another. The sub-template 1101 is a field to store information indicating the type of the sub-template, such as the name of the sub-template. The item 1102 is a field to store information indicating types of the items, such as names of one or more constituents, included in each of the sub-templates stored in the sub-template 1101. In the case where the type of the sub-template is an issuance destination, for example, the information indicating a company name, an address, a telephone number, and a name of a person in charge are stored as the constituents in the item 1102. The key character string 1103 is a field to store candidates for data on a character string (hereinafter referred to as a “key character string”) for each item 1102. The image generating unit 132 randomly selects one of the candidates for the data on the key character string stored in the key character string 1103, and generates the image of the region of the sub-template in the document image. Here, in the case where “(none)” in the field of the key character string 1103 is selected, the data in the relevant data on the key character string is treated as being absent. Each key character string stored in the key character string 1103 is associated with data on a character string (an item character string) that represents a specific item value.

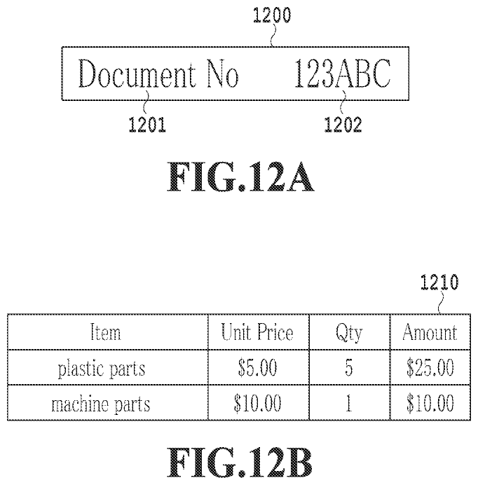

FIG. 12A is a diagram showing an example of an image (hereinafter referred to as an “item image”) 1200 which lays out the key character string and the item character string associated with the key character string in the case where the sub-template is “document name”. In the item image 1200, “Document No” in a character string 1201 is the key character string and “123ABC” in a character string 1202 is the item character string. FIG. 12B is a diagram showing an example of an item image 1210 which lays out the key character string and the item character string associated with the key character string in the case where the sub-template is “detail (tabular format)”. In the case where the sub-template is “detail (tabular format)”, the key character string and the item character string are laid out in a tabular format. The key character strings are laid out on a first row of a table while the item character strings are laid out on the rows other than the first row. Specifically, on the leftmost column of the item image 1210, “Item” is the key character string while “plastic parts” and “machine parts” are the item character string.

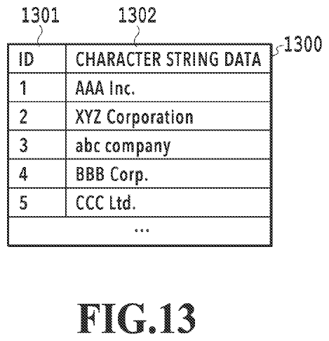

The item character string DB 1104 is a field to store character string data that represent a name, a location, and the like of a database (hereinafter referred to as an “item character string DB”) that registers candidates for the data on the item character strings corresponding to each of the key character strings. The item character string DB will be described with reference to FIG. 13. FIG. 13 is a diagram showing an example of an item character string DB 1300. Specifically, the item character string DB 1300 shown in FIG. 13 is an example of a company name DB that registers candidates for the data on the item character string corresponding to the key character string “company name”. The item key character string DB, such as the company name DB, is generated in advance by the engineer or the like and is stored in the storage unit 235 and the like.

In the item character string DB 1300, an ID 1301 and character string data 1302 are associated with each other. The ID 1301 is a field to store a number for uniquely identifying item character string data held in the item character string DB 1300. The character string data 1302 is a field to store the item character string data. The image generating unit 132 randomly selects a piece of the item character string data registered with the item character string DB depending on the character string DB indicated in the field of the item character string DB 1104, and defines the selected piece of the data as the item character string to be laid out in the document image to be generated. In the case where the field of the item character string DB 1104 has “−”, the image generating unit 132 may generate a character string, such as a random numerical string, without reference to the item character string DB and define the character string thus generated as the item character string.

The appearance frequency 1105 is a field to store a probability to lay out the item character string in the document image to be generated. The probability is defined by using a real number in a range from 0 to 1, for example. The corresponding item character string is definitely laid out in the case where the value in the field of the appearance frequency 1105 is equal to 1, while the corresponding item character string is not laid out in the case where the value is equal to 0. For example, the value of the appearance frequency 1013 regarding the item “telephone” in the sub-template “issuance destination” is equal to 0.3. Accordingly, the item character string corresponding to this item is laid out in the document image at the probability of 30%. The item name ID 1106 is a field to store the value of the item name ID shown in FIG. 8A, which is used in the case of attaching the item name ID to the item character string.

In S905 subsequent to S904, the image generating unit 132 decides whether or not it is appropriate to lay out the respective item character strings in the sub-template into the document image. The appropriateness to lay out each of the item character strings in the document image is decided at random by using a random number based on the values of the appearance frequency 1105 for each of the items of the sub-template shown in FIG. 11 as the example. Next, in S906, the image generating unit 132 selects one of the unprocessed items out of all the items decided to be laid out in S905. Then, in S907, the image generating unit 132 decides the key character string corresponding to the item selected in S906. The key character string is decided by randomly selecting one of the candidates for the key character string 1103 in the sub-template data 1100. Next, in S908, the image generating unit 132 decides the item character string corresponding to the item selected in S906. The item character string is decided by randomly selecting one of the candidates for the item character string registered with the item character string DB corresponding to the character strings stored in the field of the item character string DB 1104 of the sub-template data 1100. A character string, such as a random numerical string generated without reference to the item character string DB, may be decided as the item character string.

Then, in S909, the image generating unit 132 generates the item image by laying out the key character string decided in S907 and the item character string decided in S908, and lays out the item image in the white image generated in S901. Specifically, the image generating unit 132 generates the item image, such as the item images 1200 and 1210 shown in FIGS. 12A and 12B, and lays out the generated item image in the white image. Layout processing of the item image in the white image will be described later. Next, in S910, the image generating unit 132 generates information indicating the key character string and the item character string laid out in the white image in S909, the name of the item, and the locations in the white image of the key character string and the item character string laid out in the white image, and causes the storage unit 235 to store this information.

Then, in S911, the image generating unit 132 determines whether or not all the items decided in S905 have been selected in S906. In the case of the determination in S911 that at least one of all the items is yet to be selected, the image generating unit 132 repeatedly executes the processing from S906 to S910 until it is determined in S911 that all the items have been selected. In the case where it is determined in S911 that all the items have been selected, the image generating unit 132 determines in S912 whether or not all the sub-templates decided in S903 have been selected in S904. In the case of the determination in S912 that at least one of all the sub-templates is yet to be selected, the image generating unit 132 repeatedly executes the processing from S904 to S911 until it is determined in S912 that all the sub-templates have been selected.

In the case where it is determined in S912 that all the sub-templates have been selected, the image generating unit 132 terminates the processing of the flowchart shown in FIG. 9. The image generating unit 132 generates the document image as described above. Meanwhile, since the processing of the flowchart shown in FIG. 9 is the example of the processing in S403 of the flowchart shown in FIG. 4, the processing of the flowchart shown in FIG. 9 is executed the number of times corresponding to the number to be generated. Accordingly, the generating unit 130 will generate the document images in the number to be generated by the image generating unit 132.

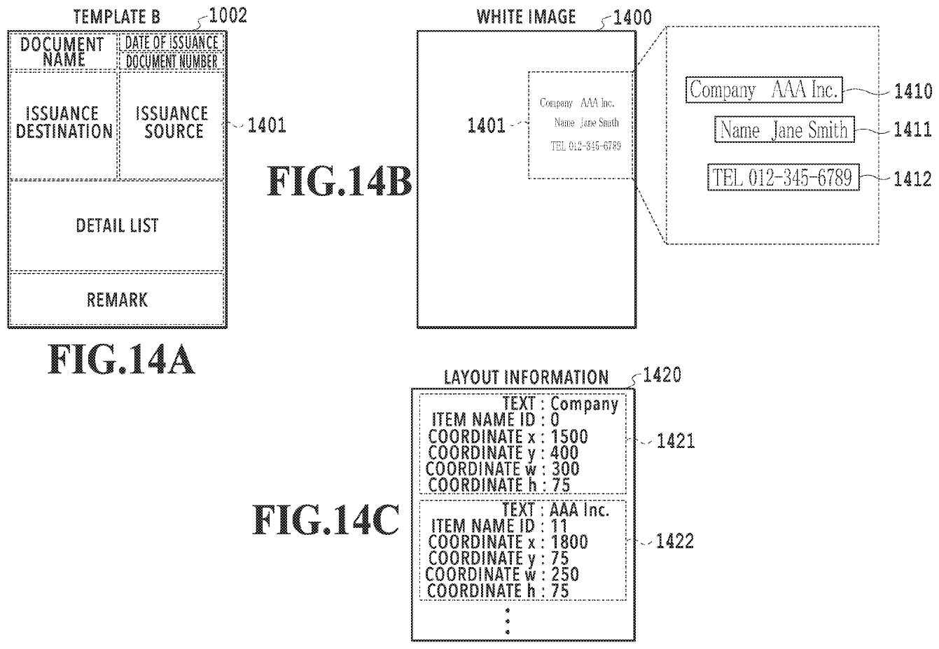

FIGS. 14A to 14C are diagrams for explaining an example of the layout processing for laying out the item images in the white image by the image generating unit 132 according to Embodiment 1. Specifically, FIG. 14A shows the template B which is the same as the template 1002 (the template B) shown in FIG. 10B. FIG. 14B is a diagram showing an example in the case where the image generating unit 132 lays out the item image in the white image. Specifically, FIG. 14B shows an example of laying out the key character strings and the item character strings corresponding to the respective items in a region 1401 corresponding to the sub-template “issuance source” among the sub-templates in the template B. To be more precise, FIG. 14B shows the example of laying out the key character strings and the item character strings corresponding to the respective items “company name”, “name of person in charge”, and “telephone”.

First, the item “company name” is selected in S906. Then, the key character string is decided to be “Company” in S907, and the item character string is decided to be “AAA Inc.” in S908. Hence, an item image 1410 corresponding to the item “company name” is generated in S909. The generated item image 1410 is laid out somewhere in the region 1401 of the sub-template “issuance source” in a white image 1400. Likewise, an item image 1411 and an item image 1412 corresponding to the respective items “name of person in charge” and “telephone” are generated and each of the item image 1411 and the item image 1412 thus generated is laid out in the region 1401. The layout of the item images corresponding to the respective items only needs to be arranged in the region 1401 in such a way that the respective item images do not overlap one another. For example, the respective item images may be laid out in accordance with left aligning, right aligning, centering, and the like with respect to the region 1401, or may be laid out at random.

FIG. 14C shows an example of information (hereinafter referred to as “layout information”) 1420 indicating the locations and the like of the key character strings and the item character strings in the white image, which is stored in the storage unit 235 and the like in S910. The layout information 1420 is stored in the form of text data in a prescribed format, such as the json format, for each of the sub-templates, and the layout information 1420 contains information indicating the locations of the key character strings and of the item character strings corresponding to the respective items included in the sub-templates. The layout information 1420 corresponding to the item image 1410 includes information 1421 which indicates a location to lay out “Company” decided as the key character string in the white image, and the like. Meanwhile, the layout information 1420 includes information 1422 which indicates a location to lay out “AAA Inc.” decided as the item character string in the white image, and the like. Regarding the information 1421 and 1422, “text” stores the data on the character string, such as the key character string and the item character string, to be laid out in the white image. Meanwhile, “item name ID” stores an ID indicating the type of the item, which is the ID to be attached to the character string, such as the key character string and the item character string. In the meantime, each “coordinate” stores information indicating the region to lay out the character string, such as the key character string and the item character string, in the white image based on an upper left end of the white image defined as the point of origin.

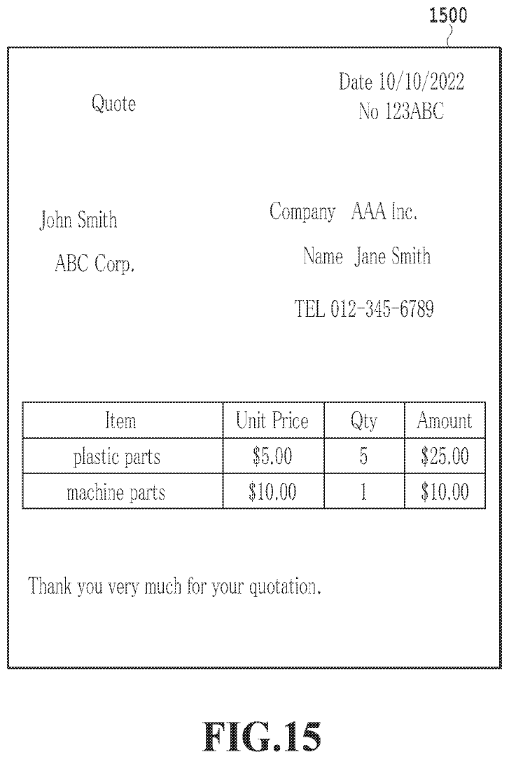

FIG. 15 is a diagram showing an example of a document image 1500 generated by the image generating unit 132 according to Embodiment 1. Regarding all the sub-templates included in the template selected in S902, the image generating unit 132 lays out the item images in the white image, which correspond to all the items included in the respective sub-templates. Thus, the image generating unit 132 generates a sentence image corresponding to this template.

### <Obtainment Processing of Learned Character String Information>

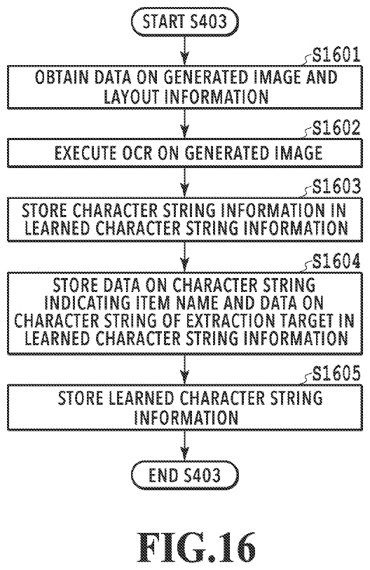

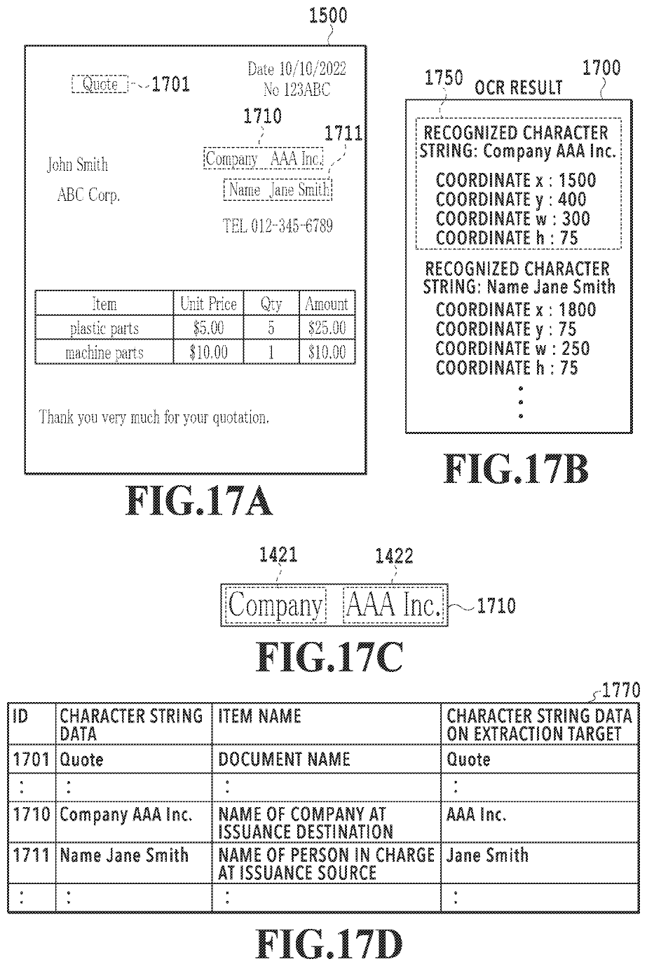

Obtainment processing of the learned character string information, or in other words, obtainment processing of the character string information and the item value information, will be described with reference to FIGS. 16 to 17D. FIG. 16 is a flowchart showing an example of a processing flow in the case where the generating unit 130 according to Embodiment 1 obtains the learned character string information, which is a flowchart showing an example of a processing flow in S404 and S405 shown in FIG. 4. First, in S1601, the character string obtaining unit 133 of the generating unit 130 obtains the data on each document image generated in S403 and the information (the layout information 1420) indicating the locations and the like of the key character strings and the item character strings in the white image. Next, in S1602, the character string obtaining unit 133 identifies the character strings included in the document image by executing the OCR processing on the document image.

FIG. 17A is a diagram showing an example of regions 1701, 1710, and 1711 of the character strings to be identified in the case where the OCR processing is executed on the document image 1500 shown as the example in FIG. 15. Meanwhile, FIG. 17B is a diagram showing an example of an OCR result 1700 in the case where the OCR processing is executed on the document image 1500 shown as the example in FIG. 15. The regions 1701, 1710, and 1711 of the character strings in the document image 1500 and the character strings identified in the respective regions, for example, are obtained by executing the OCR processing on the document image 1500. The OCR result is obtained as text data in a prescribed format, such as the json format, which holds a result of the OCR processing for each of the identified regions of the character strings.

The OCR result 1700 shows as the example in FIG. 17B indicates a character recognition result 1750 of the OCR processing on the region 1710 out of all results of the OCR processing on the document image 1500. In the OCR result 1700, “recognized character string” stores the data on the character string identified in each region. In the OCR result 1700, a coordinate x, a coordinate y, a coordinate w, and a coordinate h are pieces of information indicating the location of each region of the character string in the case where an upper left end of the document image is defined as the point of origin, and this information indicates the x coordinate, the y coordinate, the width, and the height of each region of the character string, for example.

In S1603 subsequent to S1602, the character string obtaining unit 133 obtains information (the character string information) indicating the character strings included in the document image out of the OCR result 1700, and stores the obtained character string information in the learned character string information. Specifically, the character string obtaining unit 133 stores the character strings in the OCR result 1700 corresponding to the “recognized character string” fields, respectively, in “character string data” fields of learned character string information 1770 shown in FIG. 17D. For example, the character string obtaining unit 133 stores the data on the character string “Company AAA Inc.”, which corresponds to the “recognized character string” in the character recognition result 1750 of the OCR processing, into the learned character string information 1770. To be more precise, the character string obtaining unit 133 stores the data on the relevant character string in the “character string data” field corresponding to the row having the value of the field “ID” equal to “1710” in the learned character string information 1770.

Next, in S1604, the item value obtaining unit 134 of the generating unit 130 obtains the data on the character string indicating the item name and the data on the character string of the extraction target by referring to the OCR result 1700 obtained in S1602 and the layout information 1420 generated in S910. The item value obtaining unit 134 stores the obtained data on these character strings into the learned character string information 1770. Specifically, the item value obtaining unit 134 stores the data on these character strings in the “item name” field and the “character string of extraction target” field in the learned character string information 1770.

FIG. 17C is an enlarged diagram of the region 1710 of the character string identified in the OCR processing, which is originally shown in FIG. 17A. The region 1710 of the character string is indicated with a solid line in FIG. 17C. Regions 1721 and 1722 indicated with dashed lines in FIG. 17C are regions of the key character string and of the item character string that are laid out in the case of generating the document image 1500, which are held in the layout information 1420 shown in FIG. 14B. With reference to the layout information 1420, the character strings included in the region 1710 turn out to be the character string in the region 1721 and the character string in the region 1722. Meanwhile, with reference to the “item name ID” in the layout information 1420, the value of the “item value ID” in the region 1721 turns out to be “0” and the value of the “item name ID” in the region 1722 turns out to be “11”. Moreover, with reference to FIG. 8A, the item name in the case where the item name ID has the value “11” turns out to be “name of company of issuance source”. Hence, the character string in the region 1722 turns out to be the item value of the extraction target.

As a consequence, the item value obtaining unit 134 stores the “AAA Inc.” being the character string in the region 1722 into the “character string data on extraction target” field on the row having the value “ID” in the learned character string information 1770 equal to “1710”. In the meantime, the item value obtaining unit 134 stores the character string data “name of company of issuance source” corresponding to the value “11” of the item name ID into the “item name” field on the row having the value “ID” in the learned character string information 1770 equal to “1710”. In S1605 subsequent to S1604, the item value obtaining unit 134 outputs the learned character string information 1770 to the storage unit 235 and the like so as to store the learned character string information 1770. Subsequent to S1605, the generating unit 130 terminates the processing of the flowchart shown in FIG. 16.

The document images in the number to be generated by the image generating unit 132 are different from one another. For this reason, the character string obtaining unit 133 and the item value obtaining unit 134 can obtain the learned character string information corresponding to the respective document images in which at least any of the contents of the character strings and the orders of arrangement of the character strings are different from one another. The token string generating unit 135 generates the document image token strings and the item value token strings corresponding to the respective pieces of the learned character string information thus obtained. Meanwhile, the learning data generating unit 136 generates the sets of learning data corresponding to the document image token strings and the item value token strings thus generated, respectively.

For this reason, the generating unit 130 of the learning apparatus 120 according to Embodiment 1 can generate sets of learning data in consideration of arrangement of character strings of forms in various layouts. Moreover, the generating unit 130 can generate a pseudo document image by imitating actual data, and automatically attach a ground truth label to a character string of an extraction target among character strings included in the generated document image. In this way, it is possible to generate a large number of sets of learning data to be used for supervised learning in the case of generating an item value extraction model.

Meanwhile, the generating unit 130 of the learning apparatus 120 according to Embodiment 1 can automatically generate the item value token string to be used as the ground truth label. For this reason, an engineer does not need to manually attach the ground truth label. In this way, it is possible to reduce a burden on the engineer in attaching the ground truth label. Moreover, it is also possible to reduce erroneous attachment of the ground truth label due to a human error by the engineer and the like, or to reduce inconsistent attachment of ground truth labels by two or more engineers.

In the meantime, the learning unit 121 of the learning apparatus 120 according to Embodiment 1 can subject the learning model to perform the learning as described below by using the above-described sets of learning data. Specifically, the learning unit 121 can conduct learning not only about relations among a token corresponding to a character string of an extraction target and tokens preceding or following the aforementioned token, but also about relations among tokens corresponding to character strings included in the same region or to character string across two or more regions. To be more precise, a character string, such as a key character string corresponding to an item name, that is likely to provide a clue to detection of a character string of an extraction target frequently comes into being in the same region as the character string of the extraction target. Accordingly, the learning unit 121 can also conduct learning about a tendency of unlikeliness to come into being in a different region, for instance.

Although the present embodiment has been described with the aspect of generating the document image corresponding to the layout of the form in the case of generating the learning data as an example, the document image is not limited to the one corresponding to the layout of the form. Moreover, although the present embodiment has been described with the aspect of generating the data on the document image as the pseudo data in the case of generating the learning data as an example, the pseudo data is not limited to the image data. For example, the generating unit 130 of the learning apparatus 120 may generate text data that describes a character string to be laid out in an image and a location to lay out the character string in the image by using a markup language and the like instead of the document image.

### <Extraction Processing of Character String of Extraction Target>

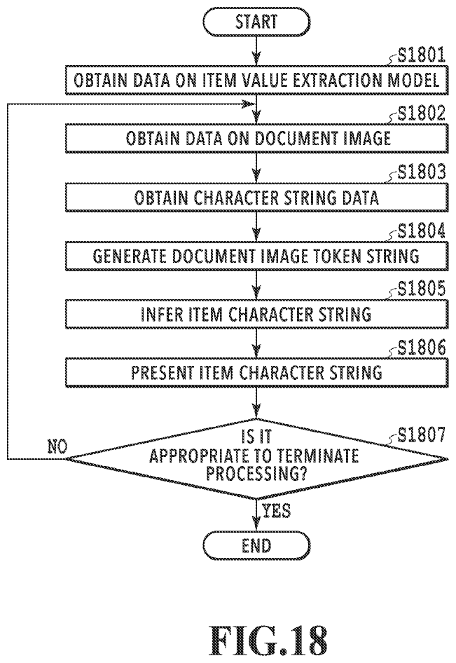

The processing in S313 and S314 by the information processing server 140 shown in FIG. 3B will be described with reference to FIG. 18. FIG. 18 is a flowchart showing an example of a processing flow by the information processing server 140 according to Embodiment 1. Here, a control program for executing respective steps shown in FIG. 18 is stored in any of the ROM 262 and the RAM 264, and the storage unit 265 of the information processing server 140, and is executed by the CPU 261 of the information processing server 140. First, in S1801, the information processing unit 141 of the information processing server 140 obtains the data on the item value extraction model which is the learned model generated by the learning apparatus 120. Specifically, the information processing unit 141 obtains the data on the item value extraction model by reading the data from the storage unit 265, for example. Next, in S1802, the information processing unit 141 obtains the data on the document image, which is obtained by scanning of the original with the image processing apparatus 110, through the external interface 268.

Then, in S1803, the information processing unit 141 executes the OCR processing on the data on the document image obtained in S1802, thereby obtaining data (the character string data) on the character strings included in the document image. Next, in S1804, the information processing unit 141 generates the document image token string based on the data on the document image obtained in S1802 and on the character string data obtained in S1803. Here, generation processing of the document image token string by the information processing unit 141 is the same as the processing in S406 by the token string generating unit 135 of the learning apparatus 120 and explanations will therefore be omitted.

Then, in S1805, the information processing unit 141 inputs the document image token string generated in S1804 to the item value extraction model obtained in S1801, and causes the item value extraction model to carry out inference processing. Thus, the information processing unit 141 causes the item value extraction model to output an item value token string having the similar structure as that of the item value token string shown in FIG. 8B, and obtains this item value token string. The inference processing in the item value extraction model according to the present embodiment is designed to determine which item name ID out of the item name IDs held on the item name ID list 800 shows as the example in FIG. 8A is probable in terms of each of the tokens included in the document image token string. Here, the information processing unit 141 may cause the item value extraction model to output probability values indicating probabilities of the respective item name IDs depending on each of the tokens included in the document image token string and may determine the item name ID having the largest probability value as the item name ID of the relevant token.

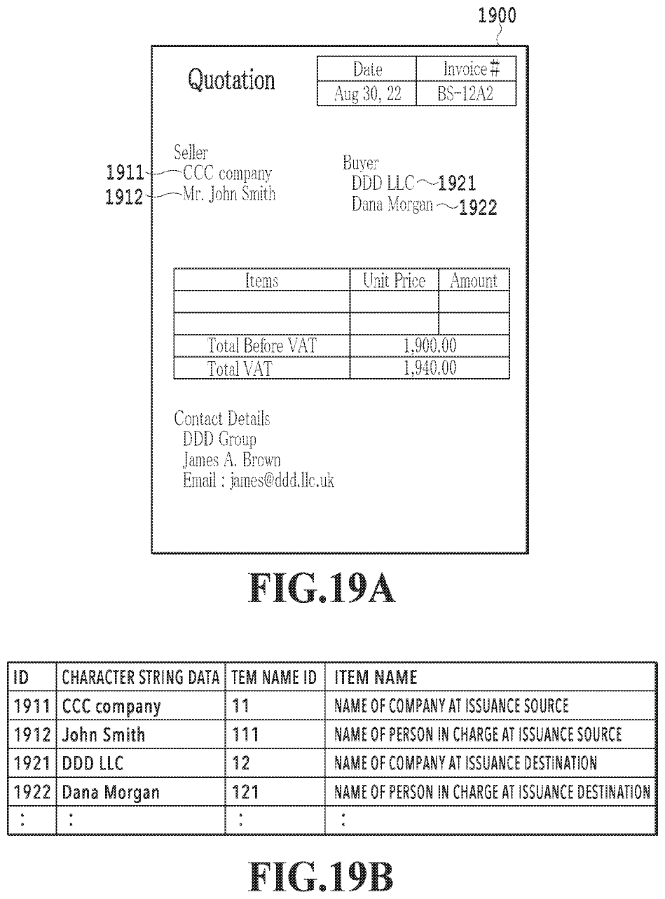

An inference result of the item value extraction model will be described with reference to FIGS. 19A and 19B. FIG. 19A is a diagram showing an example of a document image 1900 that the information processing server 140 according to Embodiment 1 obtains from the image processing apparatus 110. In FIG. 19A, character strings 1911, 1912, 1921, and 1922 show examples of the character strings identified in the OCR processing by the information processing unit 141. FIG. 19B is a diagram showing character strings corresponding to respective tokens included in the document image token string inputted to the item value extraction model, and an example of a list of item name IDs and item names corresponding to the respective tokens which represent an inference result of the item value extraction model. For example, regarding “CCC company” in the character string 1911, the list shows a result that the item name ID is inferred to be “11” and the item name is inferred to be “name of company at issuance source”. As mentioned above, the information processing unit 141 can obtain a character string, such as “CCC company” and “John Smith”, included in the document image 1900 as the character string of the item value (the item character string) of the extraction target as the inference result.

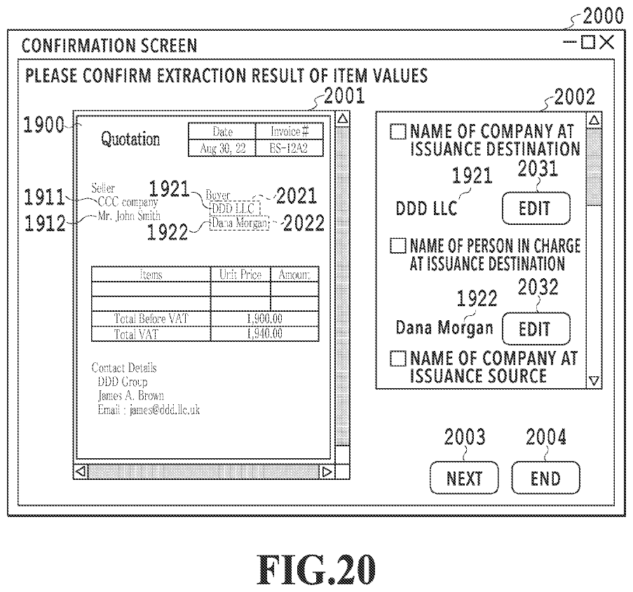

In S1806 subsequent to S1805, the information processing unit 141 presents the item character strings obtained by the inference in S1805 to the user. The presentation to the user is carried out by causing the display device 267 and the like to display a confirmation screen and the like as a display image, for example. FIG. 20 is a diagram showing an example of a confirmation screen 2000 for causing the user to confirm the item character string according to Embodiment 1. The confirmation screen 2000 includes a preview image display region 2001, a result display region 2002, a “next” button 2003, and an “end” button 2004. The item character strings obtained in S1805, such as the character strings 1921 and 1922, are displayed in the result display region 2002. Meanwhile, the user can correct an item character string by pressing an “edit” button, such as “edit” button 2031 or 2032, in the case where the OCR result of the extracted item character string such as the character string 1921 or 1922 is wrong.

The document image 1900 is displayed as a preview in the preview image display region 2001. Meanwhile, regions 2021, 2022, and the like of the extracted item character strings, such as the character strings 1921 and 1922, are highlighted on the document image 1900 displayed as the preview. A confirmation screen corresponding to the next document image is displayed in the case where the “next” button 2003 is pressed. The information processing server 140 terminates the display of the confirmation screen in the case here the “end” button 2004 is pressed.

In S1807 subsequent to S1806, the information processing unit 141 determines whether or not it is appropriate to terminate the extraction processing of the item character string. Specifically, the information processing unit 141 determines whether or not it is appropriate to terminate the extraction processing of the item character string by determining whether or not there is a request from the user to terminate the extraction processing by pressing the “end” button. In the case where there is a request from the user to continue the extraction processing by pressing the “next” button on the condition that it is determined not to terminate the extraction processing of the item character string in S1807, the information processing server 140 executes the processing from S1802 to S1806 on the next document image. The information processing server 140 terminates the processing of the flowchart shown in FIG. 18 in the case where it is determined to be appropriate to terminate the extraction processing of the item character string in S1807.

As described above, the information processing server 140 is configured to infer the character string of the extraction target by using the item value extraction model, which is generated by the learning by use of the sets of learning data generated by the generating unit 130 of the learning apparatus 120. For this reason, the information processing server 140 configured as described above can infer the character string of the extraction target at high accuracy.

### Embodiment 2

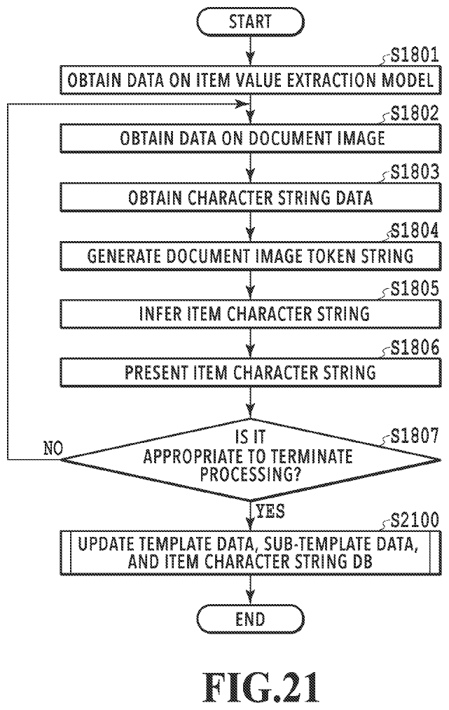

An information processing system 100 according to Embodiment 2 will be described by using the respective drawings referred to in describing Embodiment 1 and FIGS. 21 to 24. Note that the respective configurations of the information processing system 100, the image processing apparatus 110, the learning apparatus 120, and the information processing server 140 according to Embodiment 2 are the same as the configurations shown as the examples in FIGS. 1A to 2C. Embodiment 1 has been described on the assumption that the template data, the sub-template data, and the item character string DB are generated in advance by the engineer or the like. Embodiment 2 will describe an aspect of updating the template data, the sub-template data, and the item character string DB by use of the document image obtained by scanning of the original with the image processing apparatus 110. In this way, it is possible to increase a variation of the document images to be generated by the learning apparatus 120, and to generate a wider variation of the learning data as a consequence.

FIG. 21 is a flowchart showing an example of a processing flow by the information processing server 140 according to Embodiment 2. Here, a control program for executing respective steps in FIG. 21 is stored in any of the ROM 262, the RAM 264, and the storage unit 265 of the information processing server 140 and is executed by the CPU 261 of the information processing server 140. A description will be given below only of different features from the processing flow by the information processing server 140 according to Embodiment 1 described as the example in FIG. 18. First, the information processing unit 141 executes the processing from S1801 to S1807 as appropriate. In the case where it is determined to terminate the extraction processing of the item character string in S1807, the information processing unit 141 updates the template data, the sub-template data, and the item character string DB in S2100. Processing in S2100 is executed after an “end” button 2004 in the confirmation screen 2000 shown as the example in FIG. 20 is pressed by the user. Subsequent to S2100, the information processing server 140 terminates the processing of the flowchart shown in FIG. 21.

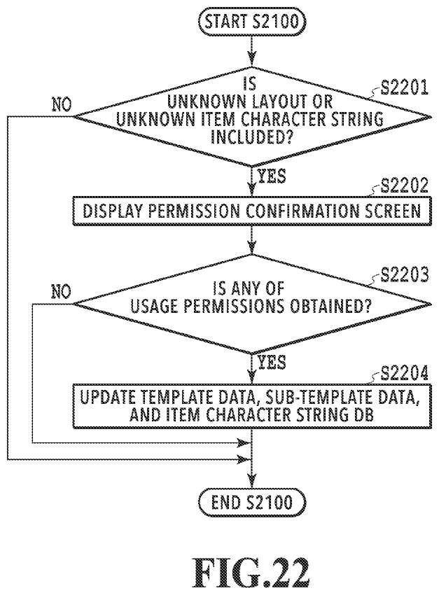

A flow of the processing in S2100 will be described with reference to FIG. 22. FIG. 22 is a flowchart showing an example of a flow of the update processing of the template data, the sub-template data, and the item character string DB by the information processing server 140 according to Embodiment 2, which is a flowchart illustrating the flow of the processing in S2100 shown in FIG. 21. First, in S2201, the information processing unit 141 determines whether or not the data on the document image obtained in S1802 represents a document image having an unknown layout and whether or not the document image includes an unknown item character string. The information processing server 140 terminates the processing of the flowchart shown in FIG. 22 in the case of the determination in S2201 that the document image does not have the unknown layout and does not include the unknown item character string. The information processing unit 141 executes processing in S2202 in the case of the determination in S2201 that the document image has the unknown layout or includes the unknown item character string.

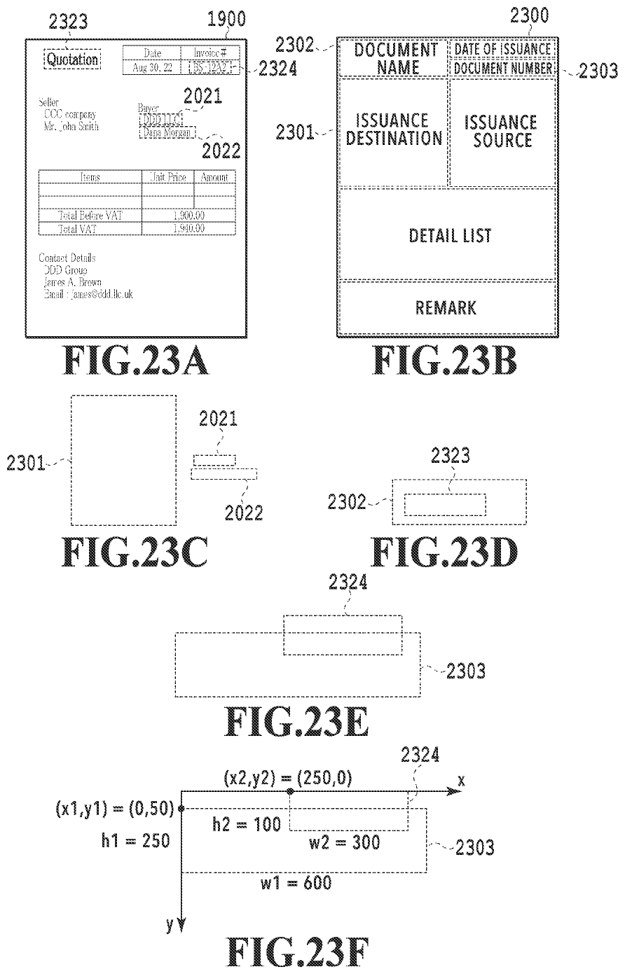

The determination as to whether the document image has the unknown layout is carried out as described below, for example. The determination is carried out based on a concordance rate between the location of the region of each item character string included in the document image 1900 shown in FIG. 20 and the location of the region of the sub-template corresponding to the item character string in the template which is indicated by each piece of the template data stored in the storage unit 235 and the like. Specific processing of the determination will be described with reference to FIGS. 23A to 23F.

FIG. 23A shows the document image 1900 illustrated in FIG. 20. The document image 1900 shown in FIG. 23A includes a number of item character strings. FIG. 23A shows a region 2021 for “name of company at issuance destination”, a region 2022 for “name of person in charge at issuance destination”, a region 2323 for “document name”, and a region 2324 for “document number” as the regions for the respective item character strings. FIG. 23B shows a template 2300 out of pieces of the template data stored in the storage unit 235 and the like. FIG. 23B shows the regions of the respective sub-templates corresponding to the item character strings in the template 2300. Specifically, FIG. 23B shows a region 2301 of a sub-template corresponding to “issuance destination”, a region 2302 of a sub-template corresponding to “document name”, and a region 2303 of a sub-template corresponding to “document number”. The information processing unit 141 obtains concordance rates of the locations of the regions 2021, 2022, 2323, and 2324 of the respective item character strings included in the document image 1900 and the locations of the regions 2301, 2302, and the 2303 of the respective sub-templates in the template 2300, respectively.

FIG. 23C shows the respective locations of the region 2021 for “name of company at issuance destination”, the region 2022 for “name of person in charge at issuance destination” in the document image 1900, and the region 2301 of the sub-template corresponding to “issuance destination” in the template 2300. The information processing unit 141 lays out these regions 2021, 2022, and 2301 on the same plane as shown in FIG. 23C, for example. Moreover, the information processing unit 141 compares the locations of the region 2021 for “name of company at issuance destination” and the region 2022 for “name of person in charge at issuance destination” with the location of the region 2301 of the sub-template corresponding to “issuance destination”. In the case of FIG. 23C, the region 2021 and the region 2022 are not included in the region 2301. Accordingly, the obtained concordance rate is equal to 0%.

FIG. 23D shows the respective locations of the region 2323 for “document name” in the document image 1900 and the region 2302 of the sub-template corresponding to “document name” in the template 2300. The information processing unit 141 lays out these regions 2323 and 2302 on the same plane as shown in FIG. 23C, for example, and compares the location of the region 2323 for “document name” in the document image 1900 with the region 2302 of the sub-template corresponding to “document name”. In the case of FIG. 23D, the region 2323 is encompassed by the region 2302. Accordingly, the obtained concordance rate is equal to 100%.

FIGS. 23E and 23F show the respective locations of the region 2324 for “document number” in the document image 1900 and the region 2303 of the sub-template corresponding to “document number” in the template 2300. The information processing unit 141 lays out these regions 2324 and 2303 on the same plane as shown in FIG. 23E, for example. Moreover, the information processing unit 141 compares the location of the region 2324 for “document number” in the document image 1900 with the region 2303 of the sub-template corresponding to “document number” in the template. In the case of FIG. 23E, a percentage of an area where the region 2324 overlaps the region 2303 is obtained as the concordance rate. In the case where the respective coordinates of the regions 2324 and 2303 have respective values shown in FIG. 23F, for example, the area of the region 2324 is calculated as w2×h2=30000. The overlapping area of the region 2324 with the region 2303 has a width equal to 300 and a height equal to 50. Accordingly, the overlapping area is calculated as 300×50=15000. The concordance rate in the case of FIG. 23F is therefore calculated as 15000/30000×100=50%.

The information processing unit 141 obtains the concordance rates regarding the regions of all the item character strings, for example, and determines that the document image 1900 has the unknown layout in the case where a statistical value, such as an average value, a median value, a mode value, and a minimum value, of the obtained concordance rates falls below a prescribed threshold. The threshold may be an arbitrary value, such as 75%, as long as the threshold enables the determination as to whether or not the document image 1900 has the unknown layout.

For example, the determination as to whether or not the document image 1900 includes the unknown item character string is carried out as follows. The determination is carried out by determining whether or not each of the item character strings extracted from the document image 1900, such as the character strings 1921 and 1922, shown in FIG. 20 is registered with the item character string DB, for instance. Specifically, the information processing unit 141 determines whether or not the character string 1921 “DDD LLC” being the item character string corresponding to “name of company at issuance destination” is registered with the “company name DB” which is the item character string DB 1300 shown in FIG. 13, for example. Meanwhile, the information processing unit 141 determines whether or not the character string 1922 “Dana Morgan” being the item character string is registered with a “personal name DB” which is a not-illustrated item character string DB. The information processing unit 141 carries out the similar determination on all the item character strings extracted from the document image 1900. In the case of the determination that at least one of all the item character strings is not registered with the item character string DB, the information processing unit 141 determines that the document image 1900 includes the unknown item character string.

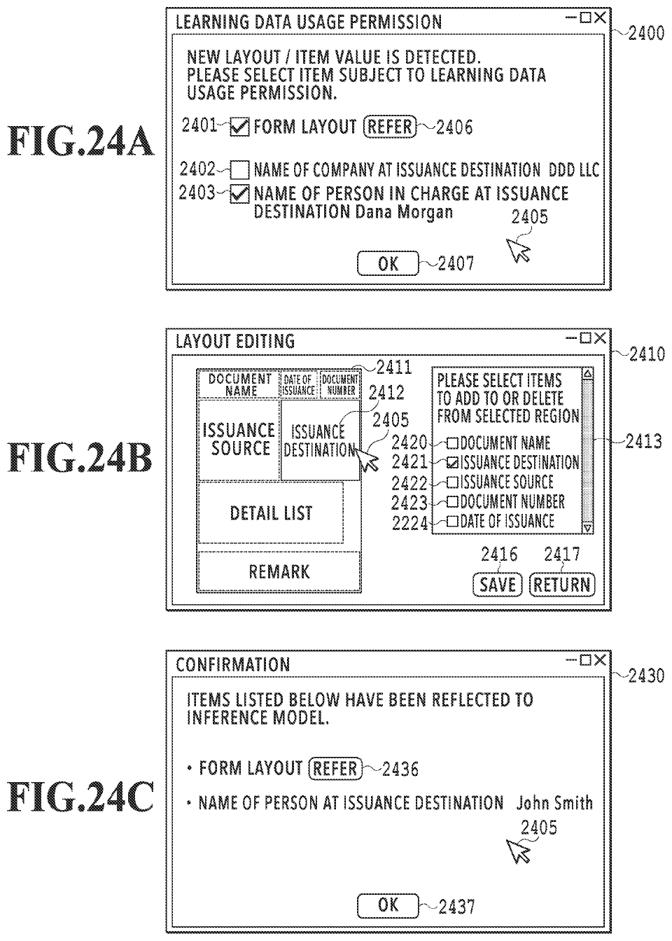

In S2202, the information processing unit 141 presents information to the user in order to seek for a permission as to whether or not it is appropriate to use the unknown layout or the unknown item character string as the learning data. The presentation to the user is carried out by causing the display device 267 and the like to display a permission confirmation screen and the like as a display image, for example. FIG. 24A is a diagram showing an example of a permission confirmation screen 2400 according to Embodiment 2. The permission confirmation screen 2400 includes check boxes 2401, 2402, and 2403, a “refer” button 2406, and an “OK” button 2407. A pointer 2405 indicates an operation position by the user on the screen. The information processing unit 141 accepts operation input from the user with the input device 266. The check box 2401 is an entry field for inputting whether or not it is appropriate to permit usage of the unknown layout, which is inputted by operation input from the user. Likewise, check boxes 2402 and 2403 are entry fields for inputting whether or not it is appropriate to permit usage of the unknown item character strings, which are inputted by operation input from the user.

In the case where the “refer” button 2406 is pressed, an editing screen or the like is displayed in order to refer to or edit the layout detected as the unknown layout. FIG. 24B is a diagram showing an example of an editing screen 2410 for referring to or editing the layout. A provisional template 2411 corresponding to the layout detected as the unknown layout is displayed in the editing screen 2410. The regions of the sub-templates, such as a sub-template 2412, are illustrated on the template 2411. The user can adjust a location or a size of the region of each sub-template by operation input with the input device 266. Meanwhile, in the case where the sub-template in the template 2411 is selected, an item editing screen 2413 corresponding to the selected sub-template is displayed in the editing screen 2410. The user can add or delete items in the selected sub-template by operation input to the check boxes 2420 to 2424.

A “save” button 2416 and a “return” button 2417 are included in the editing screen 2410. In the case where the “save” button 2416 is pressed, the information processing unit 141 generates the data on the edited template 2411 and the sub-template data corresponding to the edited template 2411, and displays the permission confirmation screen 2400. In the case where the “return” button 2417 is pressed, the information processing unit 141 discards the edited contents of the template 2411 in progress, and displays the permission confirmation screen 2400.

After the “OK” button 2407 shown in FIG. 24A is pressed, the information processing unit 141 executes processing of S2203. In S2203, the information processing unit 141 determines whether or not at least any of a permission to use the layout detected as the unknown layout and a permission to use the item character string detected as the unknown item character string is obtained. Specifically, the information processing unit 141 determines the presence or absence of the permission to use the layout or the item character string by determining whether or not information indicating the permission of usage is inputted to any of the check boxes 2401, 2402, and 2403 shown in FIG. 24A. The information processing unit 141 executes processing of S2204 in the case where it is determined in S2203 that the permission to use any of the layout and the item character string is obtained. The information processing server 140 terminates the flowchart shown in FIG. 22 in the case where it is determined in S2203 that none of the permissions of usage is obtained.

In S2204, the information processing unit 141 transmits the data on the edited template 2411 corresponding to the unknown layout permitted to use and the sub-template data corresponding to the template 2411 to the learning apparatus 120. The learning apparatus 120 causes the storage unit 235 and the like to store the data on the template 2411 and the sub-template data. Moreover, in S2204, the information processing unit 141 sends the learning apparatus 120 the data on the unknown character string permitted to use. The learning apparatus 120 registers the data on the item character string with the item character string DB corresponding to the relevant item character string, which is stored in the storage unit 235 and the like. Thus, the information processing unit 141 updates the template data corresponding to the unknown layout and the sub-template data permitted to use, and the item character string DB. Note that the update of the template data and the sub-templated data stated herein means an act of newly adding the template data corresponding to the unknown layout and the sub-template data permitted to use.

Subsequent to S2204, the information processing server 140 terminates the processing of the flowchart shown in FIG. 22. After the termination of the processing of the flowchart, the learning apparatus 120 newly generates a document image by using the newly added template data and sub-template data as well as the updated item character string DB. Meanwhile, the learning apparatus 120 additionally generates a set of learning data corresponding to this document image by using the data on the generated document image. Moreover, the learning apparatus 120 carries out additional learning of the item value extraction model by using the additionally generated set of learning data. Furthermore, the information processing server 140 extracts the character string of the extraction target included in the document image, which is obtained by scanning of the original with the image processing apparatus 110 while using the additionally learned item value extraction model.

In the case where the information processing server 140 extracts the character string of the extraction target by using the additionally learned item value extraction model, the information processing unit 141 may present the updated status of the item value extraction model to the user. The presentation to the user is carried out by displaying an update confirmation screen and the like on the display device 267 and the like as a display image, for example. FIG. 24C is a diagram showing an example of an update confirmation screen 2430 according to Embodiment 2. The update confirmation screen 2430 includes a “refer” button 2436 and an “OK” button 2437. In the case where the “refer” button 2436 is pressed, the information processing unit 141 displays a confirmation screen and the like to display the newly added template on the display device 267 and the like. The information processing unit 141 terminates the display of the update confirmation screen 2430 in the case where the “OK” button 2437 is pressed. The above-described display of the update confirmation screen 2430 enables the user to recognize that the item value extraction model is updated. Moreover, the display of the confirmation screen to display the newly added template from the update confirmation screen 2430 enables the user to recognize what type of the template is added.

According to the information processing system 100 configured as described above, it is possible to update the template data, the sub-template data, and the item character string DB by using the document image obtained by scanning of the original with the image processing apparatus 110. In this way, it is possible to increase a variation of the document images to be generated by the learning apparatus 120, and to generate a wider variation of the sets of learning data as a consequence. The additional learning of the item value extraction model by use of the above-mentioned sets of learning data makes it possible to improve inference accuracy of the item value extraction model. In particular, the document image can be generated in consideration of the layout of the form employed by the user in actual operations or the character strings included in the form. Accordingly, it is possible to improve inference accuracy of the character string of the extraction target in the document image, which is obtained by scanning the original with the image processing apparatus 110 in an actual operation.

Embodiment 2 has described the aspect of obtaining the permission to use the layout detected as the unknown layout and the permission to use the item character string detected as the unknown item character string from the user. However, the present disclosure is not limited to this configuration. To be more precise, the above-described permissions to use the layout detected as the unknown layout and the item character string detected as the unknown item character string may be omitted. By updating the template data, the sub-template data, and the item character string DB based on the above described usage permissions, the user can strictly manage information on customers and individuals.

### Modified Example of Embodiment 2

Embodiment 2 has described the aspect in which the information processing server 140 updates the template data, the sub-template data, and the item character string DB by using the document image obtained by scanning of the original with the image processing apparatus 110. The update of the template data, the sub-template data, and the item character string DB is not limited to the processing by the information processing server 140. Specifically, the learning apparatus 120 may update the template data, the sub-template data, and the item character string DB by using the document image obtained by scanning of the original with the image processing apparatus 110. In this case, the learning apparatus 120 does not always have to obtain the above-described permissions from the user in the case of updating the template data, the sub-template data, and the item character string DB. At least part of the template data, the sub-template data, and the item character string DB can be generated semi-automatically. In this way, it is possible to reduce a burden on the engineer in generating the template data, the sub-template data, and the item character string DB.

### Embodiment 3

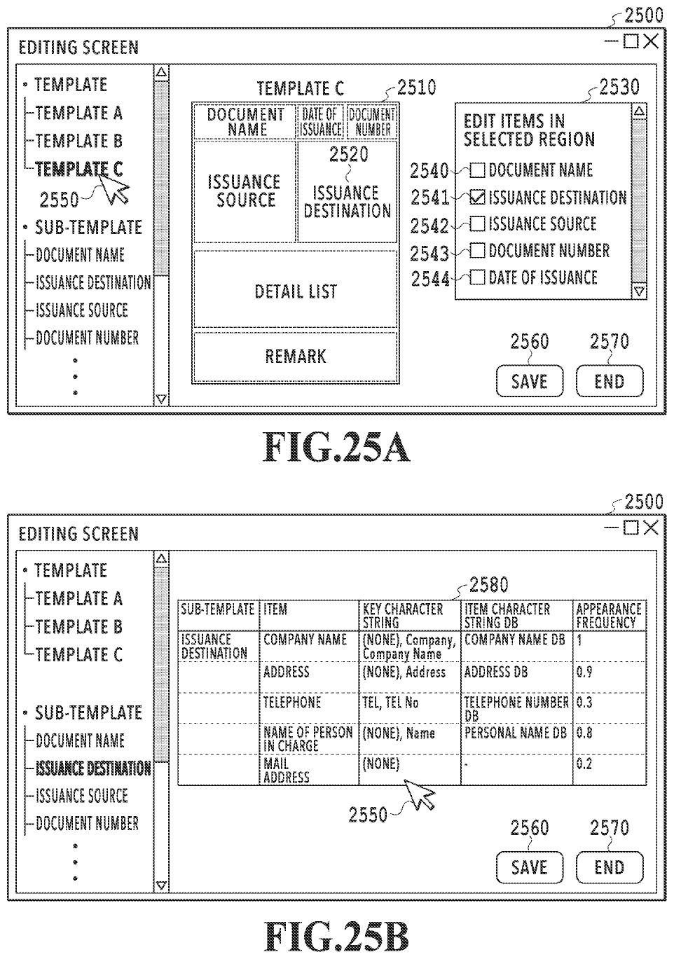

An information processing system 100 according to Embodiment 3 will be described by using the respective drawings referred to in describing Embodiment 1 and FIGS. 25A and 25B. Note that the respective configurations of the information processing system 100, the image processing apparatus 110, the learning apparatus 120, and the information processing server 140 according to Embodiment 3 are the same as the configurations shown as the examples in FIGS. 1A to 2C. Embodiment 1 has been described on the assumption that the template data and the sub-template data are generated in advance by the engineer or the like. Embodiment 3 will describe an aspect of editing the template data and the sub-template data by suing an editing screen to be displayed on the display device 237.

FIGS. 25A and 25B are diagrams showing an example of an editing screen 2500 which the learning apparatus 120 according to Embodiment 3 causes the display device 237 to display. FIG. 25A is an example of the editing screen 2500 for editing the template data. The editing screen 2500 shown in FIG. 25A includes a display region for a template 2510, an item editing region 2530, a “save” button 2560, and an “end” button 2570. Regions for the respective sub-templates in the template 2510, such as a region for a sub-template 2520 corresponding to “issuance destination”, are displayed in the display region for the template 2510. A pointer 2550 indicates an operation position by the engineer on the screen. For example, the CPU 231 accepts operation input from the engineer with the input device 236.

The engineer can edit data on the template 2510 by adjusting a location or a size of the region of each sub-template in the template 2510 by operation input with the input device 236. In the case where a region of a certain sub-template in the template 2510 is selected, check boxes 2540 to 2544 are displayed in the item editing region 2530. The engineer can add or delete items in the sub-template by carrying out operation input to the check boxes 2540 to 2544. Meanwhile, the engineer can switch the template data on an editing target by selecting a template name displayed in the template selecting region, which is displayed on a left part of the editing screen 2500 shown in FIG. 25A. In the case where the “save” button 2560 is pressed, the edited data on the template 2510 is stored in the storage unit 235 and the like by means of overwriting and the like. The display of the editing screen 2500 shown in FIG. 25A is terminated in the case where the “end” button 2570 is pressed.

FIG. 25B shows an example of the editing screen 2500 for editing the sub-template. The editing screen 2500 shown in FIG. 25B includes a list 2580 of items included in the sub-template, the “save” button 2560, and the “end” button 2570. First, the engineer selects a sub-template name displayed at the left part on the editing screen 2500 shown in FIG. 25B by operation input with the input device 236. As a consequence of this selecting operation, the list 2580 of the items included in the sub-template corresponding to the selected sub-template name is displayed in the editing screen 2500.

The engineer can edit the character strings in respective cells on the list 2580 of the items by operation input with the input device 236. Moreover, the engineer can add a new item to the list 2580 of the items by operational input with the input device 236. Specifically, the engineer can add an item “mail address” as a key character string to an item “issuance destination” on the list 2580 of the items. In the case where the “save” button 2560 is pressed, the edited data on the sub-template is stored in the storage unit 235 and the like by means of overwriting and the like. The display of the editing screen show in FIG. 25B is terminated in the case where the “end” button 2570 is pressed.

According to the learning apparatus 120 configured as described above, it is possible to edit the template data and the sub-template data stored in advance in the storage unit 235 and the like. As a consequence, the engineer can edit the template data and the sub-template data used for learning the learning model by using the editing screen in the case of generating or developing the item value extraction model, for example.

### Other Embodiments

The foregoing embodiments have been described on the assumption that the learning apparatus 120 has the function to generate the learning data and the function to cause the learning model to perform the learning. However, the configuration of the learning apparatus 120 is not limited to these functions. For example, the learning apparatus 120 may be formed separately from an information processing apparatus having a function to generate the learning data and a learning apparatus having a function to cause the learning model to perform the learning. Meanwhile, the foregoing embodiments have been described on the assumption that the information processing system 100 includes the learning apparatus 120 having the function to generate the learning data and the function to cause the learning model to perform the learning, and the information processing server 140 having the function to infer the character string of the extraction target. However, the configuration of the information processing system 100 is not limited to this configuration. For example, the information processing system 100 may include an information processing apparatus provided with all these functions.

In the meantime, the foregoing embodiments have described the aspect in which the set of learning data includes the character token string generated based on the document image that is generated based on the template data, and the item value token string formed by replacing the respective character string tokens with the ground truth labels. However, the set of learning data is not limited to the above-described set. For example, the set of learning data may include data on a document image generated based on template data and labeled training data obtained by attaching a ground truth label to a character string included in the document image. In this case, data on the document image is inputted to the learning model and the learning model carries out OCR processing and generation processing of a token string, for example. The learning unit 121 of the learning apparatus 120 causes the learning model to perform the learning while changing parameters of the learning model by comparing a named entity inferred by the learning model with the character string of the labeled training data as well as the ground truth label.

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to generate learning data corresponding to documents in various layouts.

While the present disclosure has described exemplary embodiments, it is to be understood that some embodiments of the disclosure are not limited to the disclosed exemplary embodiments. The scope of the following claims is to be accorded the broadest interpretation so as to encompass all such modifications and equivalent structures and functions.

This application claims priority to Japanese Patent Application No. 2023-7587, which was filed on Jan. 20, 2023 and which is hereby incorporated by reference wherein in its entirety.

What is claimed is:

1. An information processing apparatus configured to generate learning data used for generating a learned model, the information processing apparatus comprising:
one or more processors; and
one or more memories storing one or more programs configured to be executed by the one or more processors, the one or more programs including instructions for
generating layout data indicating a layout of a character string based on template data to define a layout of a document, and
generating the learning data based on the generated layout data, wherein the generated learning data are used for generating the learned model that extracts a named entity from a document image.

2. The information processing apparatus according to claim 1, wherein image data in which an image of the character string is laid out is generated as the layout data.

3. The information processing apparatus according to claim 2, wherein the image data is generated as the learning data.

4. The information processing apparatus according to claim 2, wherein
the character string included as the image in the image data is identified by carrying out OCR processing on the image data, and
the learning data is generated based on the identified character string.

5. The information processing apparatus according to claim 1, wherein
the template data includes region information defining locations and sizes of respective segmented regions obtained by segmenting the layout of the document into the regions, and
the layout data is generated by deciding the layout of the character string based on the region information.

6. The information processing apparatus according to claim 5, wherein
each of the segmented regions is decided as to whether or not it is appropriate to lay out the character string in the segmented region, and
the layout of the character string in the segmented region is decided regarding the segmented region decided to be appropriate to lay out the character string.

7. The information processing apparatus according to claim 6, wherein
the template data includes information indicating a probability to lay out the character string in each of the segmented regions, and
each of the segmented regions is decided as to whether or not it is appropriate to lay out the character string in the segmented region based on the information indicating the probability.

8. The information processing apparatus according to claim 1, wherein the character string to be laid out is decided out of predetermined character string candidates.

9. The information processing apparatus according to claim 8, wherein
the template data includes information indicating a probability to lay out each of the character string candidates as the character string, and
the character string to be laid out is decided out of the character string candidates based on the information indicating the probability.

10. The information processing apparatus according to claim 8, wherein the one or more programs further include instructions for attaching a ground truth label based on the template data and data on the character string candidates.

11. The information processing apparatus according to claim 1, wherein the one or more programs further include instructions for generating new template data based on a layout of a character string included in the document image in a case where a layout of the document image being a target of extraction of the named entity and the layout of the document defined by the template data are different from each other.

12. The information processing apparatus according to claim 11, wherein the template data is generated in a case where a permission to generate the new template data based on the layout of the character string included in the document image is obtained from a user.

13. The information processing apparatus according to claim 1, wherein the one or more programs further include instructions for adding a character string included in the document image to a candidate for a character string to be laid out in a case where a character string included in the document image being a target of extraction of the named entity is not included in the candidate for the character string.

14. The information processing apparatus according to claim 13, wherein the character string included in the document image is added to the candidate for the character string in a case where a permission to add the character string included in the document image to the candidate for the character string is obtained from a user.

15. An information processing system comprising:
one or more processors; and
one or more memories storing one or more programs configured to be executed by the one or more processors, the one or more programs including instructions for
generating layout data indicating a layout of a character string based on template data to define a layout of a document,
generating learning data based on the generated layout data,
causing a learning model to perform learning based on the generated learning data to generate a learned model that extracts a named entity from a document image, and
extracting the named entity from the document image by using the generated learned model.

16. A non-transitory computer-readable storage medium storing a program for causing a computer to perform:
generating layout data indicating a layout of a character string based on template data to define a layout of a document; and
generating learning data based on the generated layout data, wherein the generated learning data are used for generating a learned model that extracts a named entity from a document image.
